(19) United States
(12) Patent Application Publication
(10) Pub. No.: US 2025/0048136 A1
(43) Pub. Date: Feb. 6, 2025

(54) MANAGING A WIRELESS DEVICE WHICH HAS AVAILABLE A MACHINE LEARNING MODEL THAT IS OPERABLE TO CONNECT TO A COMMUNICATION NETWORK

(71) Applicant: Telefonaktiebolaget LM Ericsson (publ), Stockholm (SE)

(72) Inventors: Reza MOOSAVI, LINKÖPING (SE); Henrik RYDÉN, STOCKHOLM (SE); Erik G. LARSSON, LINKÖPING (SE); Martin ISAKSSON, STOCKHOLM (SE); Mårten SUNDBERG, ÅRSTA (SE); Roy TIMO, KUNGSÄNGEN (SE)

(73) Assignee: Telefonaktiebolaget LM Ericsson (publ), Stockholm (SE)

(21) Appl. No.: 18/718,747

(22) PCT Filed: Dec. 13, 2021
(86) PCT No.: PCT/SE2021/051243

§ 371 Date: Jun. 11, 2024

(51) Int. Cl. H04W 24/02; H04L 41/16

(52) U.S. Cl. CPC H04W 24/02; H04L 41/16

(57) ABSTRACT

A method (100) is disclosed for managing a wireless device that is operable to connect to a communication network, wherein the communication network comprises a Radio Access Network (RAN), and wherein the wireless device has available for execution a Machine Learning (ML) model that is operable to provide an output, on the basis of which a RAN operation performed by the wireless device may be configured. The method, performed by a RAN node of the communication network, comprises, on fulfilment of a trigger condition, causing an ML model Assurance Information, MAI, Request to be sent to the wireless device (110), the MAI Request comprising an indication of the ML model to which the MAI Request relates. The method further corpses receiving, from the wireless device, an MAI Response, wherein the MAI Response comprises ML model characteristic information generated by the wireless device using the ML model (120), and configuring the RAN operation performed by the wireless device according to the received MAI Response (130).

### TECHNICAL FIELD

The present disclosure relates to methods for managing a wireless device that is operable to connect to a communication network, the methods performed by a Radio Access Network (RAN) node of the communication network, and by the wireless device. The present disclosure also relates to a RAN node for managing a wireless device that is operable to connect to a communication network, a wireless device, and to a computer program product configured, when run on a computer to carry out methods for managing a wireless device.

### BACKGROUND

Providing support for Artificial Intelligence (AI) and Machine Learning (ML) is an ongoing challenge for the Third Generation Partnership Project (3GPP). A proposal has been made to study RAN intelligence applicability and associated use cases (including energy efficiency, RAN optimization, etc.), enabled by data Collection. Specific questions for study include, for example:
How different use cases impact the overall AI framework, i.e., how the data is stored across the different nodes
Model deployment aspects
Model supervision aspects.

Most of current proposals cover signaling aspects related to new input and output information for ML models. Another potential AI/ML application for networks is to signal an ML model to a device. This is discussed in a non-published internal reference, according to which a model is signaled to a device in order to facilitate improved radio network operations. By signaling a model to the device, the network can move some calculation to the device, which provides several benefits including:
Removing the requirement for the device to signal input data for the ML model to the network.
Possibility to execute the ML model more frequently at the device, for example whenever the device has received new (ML model) input data.
A model executed on the device leads to base station resource savings.

AI/ML is expected to be a vital component in 6G systems, and a key question is how to use AI/ML capabilities in the most efficient manner. What level of intelligence should reside in the device and what level in the network is an important part of this question.

Many radio network operations can be improved by AI/ML. As discussed in the above mentioned non-published internal reference, several possible use cases for AI/ML could benefit from signaling a model that is trained at the network to the device. Such use cases include radio networking operations performed by the user device that could be executed with a configured model. Examples include beam measurement prediction, secondary carrier prediction
signal quality drop prediction, and compression of channel state information.

In a system in which the network (NW) can download ML models to a device, the NW has no way of knowing whether or not a device is using the latest model downloaded to the device for inference. For example, the device could take shortcuts in implementation of the ML model, for example by quantizing or pruning a neural network in order to save memory, or only using parts of the model in case of an ensemble-based method (for example a random forest model). The device could alternatively use a completely different model. In another example, the device could consider downloading the model to require too much overhead. In particular, it might consider an old, previously downloaded, model to be good enough. However, an old model might not cover changes in the network such as new deployments of base stations or new cell shapes (following a change in antenna tilt for example). This can lead to suboptimal or erroneous performance from the downloadable ML-models. Finally, during training of a collaborative machine learning model, the device could submit updates based on old or out of date machine learning models. This slows down training, or in a worst case might cause the collaborative model to diverge.

The above discussed behaviour of a device can lead to unexpected behaviours for radio network operations relying on the device-executed ML-model. These consequences apply both to inference and to training of ML models. In the case of inference, the ML model used impacts performance for the device itself, but may also, depending on the use-case, indirectly impact the NW as a whole through the actions taken as a result of using the ML model. In the case of training, if the ML model is to be updated in a collaborative machine learning setting, an incorrect update to a collaborative machine learning model reduces performance for all other devices training and using that collaborative machine learning model.

In 3GPP, Radio Access Network (RAN) working group 4 (RAN4) performs simulations of diverse system scenarios and derives the minimum requirements for transmission and reception parameters, and for channel demodulation. Once these requirements are set, the group defines the test procedures that will be used to verify them. In order to understand if a model is the actual downloaded model, RAN4 could define a test that requires the model output to be in a certain range for a certain scenario. However, how input errors, such as signal quality measurement errors, can propagate through the model can be extremely difficult to determine, and it can also be challenging to determine whether a large deviation in model output from a reference value is caused by input errors or by use of an incorrect model.

### SUMMARY

It is an aim of the present disclosure to provide methods, a RAN node, a wireless device and a computer readable medium which at least partially address one or more of the challenges discussed above. It is a further aim of the present disclosure to provide methods, a RAN node, a wireless device, and a computer readable medium which cooperate to enable the RAN node to determine whether or not a wireless device is using the correct version of an ML model, and to configure a related RAN operation accordingly.

According to a first aspect of the present disclosure, there is provided a method for managing a wireless device that is operable to connect to a communication network, wherein the communication network comprises a Radio Access Network (RAN). The wireless device has available for execution a Machine Learning (ML) model that is operable to provide an output, on the basis of which a RAN operation performed by the wireless device may be configured. The method, performed by a RAN node of the communication network, comprises on fulfilment of a trigger condition, causing an ML model Assurance Information (MAI) Request to be sent to the wireless device, the MAI Request comprising an indication of the ML model to which the MAI Request relates. The method further comprises receiving, from the wireless device, an MAI Response, wherein the MAI Response comprises ML model characteristic information generated by the wireless device using the ML model. The method further comprises configuring the RAN operation performed by the wireless device according to the received MAI Response.

According to another aspect of the present disclosure, there is provided a method for managing a wireless device that is operable to connect to a communication network, wherein the communication network comprises a RAN. The wireless device has available for execution an ML model that is operable to provide an output, on the basis of which a RAN operation performed by the wireless device may be configured. The method, performed by the wireless device, comprises receiving, from a RAN node of the communication network, an MAI Request, the MAI Request comprising an indication of the ML model to which the MAI Request relates, and generating ML model characteristic information using the ML model indicated in the MAI Request. The method further comprises transmitting, to the RAN node, an MAI Response, wherein the MAI Response comprises the generated ML model characteristic information.

According to another aspect of the present disclosure, there is provided a computer program product comprising a computer readable medium, the computer readable medium having computer readable code embodied therein, the computer readable code being configured such that, on execution by a suitable computer or processor, the computer or processor is caused to perform a method according to any one of the aspects or examples of the present disclosure.

According to another aspect of the present disclosure, there is provided a RAN node of a communication network comprising a RAN, wherein the RAN node is for managing a wireless device that is operable to connect to a communication network. The wireless device has available for execution an ML model that is operable to provide an output, on the basis of which a RAN operation performed by the wireless device may be configured. The RAN node comprises processing circuitry configured to cause the RAN node to, on fulfilment of a trigger condition, cause an MAI Request to be sent to the wireless device, the MAI Request comprising an indication of the ML model to which the MAI Request relates. The processing circuitry is further configured to cause the RAN node to receive, from the wireless device, an MAI Response, wherein the MAI Response comprises ML model characteristic information generated by the wireless device using the ML model. The processing circuitry is further configured to cause the RAN node to configure the RAN operation performed by the wireless device according to the received MAI Response.

According to another aspect of the present disclosure, there is provided a wireless device that is operable to connect to a communication network, wherein the communication network comprises a RAN. The wireless device has available for execution an ML model that is operable to provide an output, on the basis of which a RAN operation performed by the wireless device may be configured. The wireless device comprises processing circuitry configured to cause the wireless device to receive, from a RAN node of the communication network, an MAI Request, the MAI Request comprising an indication of the ML model to which the MAI Request relates. The processing circuitry is further configured to cause the wireless device to generate ML model characteristic information using the ML model indicated in the MAI Request, and to transmit, to the RAN node, an MAI Response, wherein the MAI Response comprises the generated ML model characteristic information.

Aspects and examples of the present disclosure thus provide methods, a RAN node, a wireless device and a computer readable medium that enable a RAN node to determine, via ML model characteristic information, whether or not an ML model is correctly obtained by a wireless device, and whether the correct version of the ML model is present on the device, meaning the device has access to the ML model for use in connection with a RAN operation. The characteristic information may then be used by the RAN node to configure the RAN operation accordingly, for example by compensating for information provided by the device that may have been generated using an incorrect or out of date version of the ML model.

For the purposes of the present disclosure, the term “ML model” encompasses within its scope the following concepts:
Machine Learning algorithms, comprising processes or instructions through which data may be used in a training process to generate a model artefact for performing a given task, or for representing a real world process or system;
the model artefact that is created by such a training process, and which comprises the computational architecture that performs the task; and
the process performed by the model artefact in order to complete the task.

References to “ML model”, “model”, model parameters”, “model information”, etc., may thus be understood as relating to any one or more of the above concepts encompassed within the scope of “ML model”.

### BRIEF DESCRIPTION OF THE DRAWINGS

For a better understanding of the present disclosure, and to show more clearly how it may be carried into effect, reference will now be made, by way of example, to the following drawings in which:

FIG. 1 is a flow chart illustrating process steps in a method for managing a wireless device;

FIG. 2 is a flow chart illustrating process steps in another example of a method for managing a wireless device;

FIGS. 3a to 3e illustrate examples of different ML model characteristic information;

FIGS. 4a to 4c show a flow chart illustrating process steps in another example of a method for managing a wireless device;

FIGS. 5a and 5b show a flow chart illustrating process steps in another example of a method for managing a wireless device;

FIGS. 6a to 6e illustrate examples of different sub steps that may be performed as part of the methods of FIGS. 2 and 4a to 4c;

FIG. 7 is a block diagram illustrating functional modules in a RAN node;

FIG. 8 is a block diagram illustrating functional modules in another example of a RAN node;

FIG. 9 is a block diagram illustrating functional modules in a wireless device;

FIG. 10 is a block diagram illustrating functional modules in another example of a wireless device;

FIG. 11 shows an example signaling exchange for a first example of ML model characteristic information;

FIG. 12 shows an example signaling exchange for a second example of ML model characteristic information;

FIG. 13 shows another example signaling exchange for the second example of ML model characteristic information;

FIG. 14 shows an example signaling exchange for a third example of ML model characteristic information;

FIG. 15 shows an example signaling exchange for a fifth example of ML model characteristic information;

FIG. 16 illustrates a wireless network in accordance with some examples;

FIG. 17 illustrates a User Equipment in accordance with some examples;

FIG. 18 illustrates a virtualization environment in accordance with some examples;

FIG. 19 illustrates a telecommunication network connected via an intermediate network to a host computer in accordance with some examples;

FIG. 20 illustrates a host computer communicating via a base station with a user equipment over a partially wireless connection in accordance with some examples;

FIG. 21 illustrates methods implemented in a communication system including a host computer, a base station and a user equipment in accordance with some examples;

FIG. 22 illustrates methods implemented in a communication system including a host computer, a base station and a user equipment in accordance with some examples;

FIG. 23 illustrates methods implemented in a communication system including a host computer, a base station and a user equipment in accordance with some examples; and

FIG. 24 illustrates methods implemented in a communication system including a host computer, a base station and a user equipment in accordance with some examples.

### DETAILED DESCRIPTION

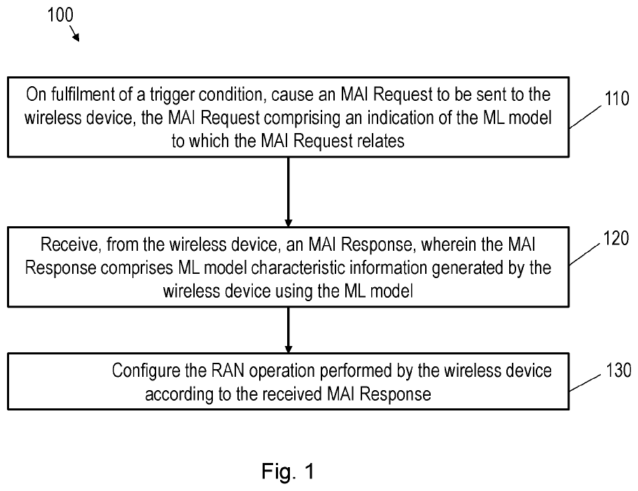

FIG. 1 is a flow chart illustrating process steps in a method 100 for managing a wireless device that is operable to connect to a communication network, wherein the communication network comprises a Radio Access Network (RAN), and wherein the wireless device has available for execution a Machine Learning (ML) model that is operable to provide an output, on the basis of which a RAN operation performed by the wireless device may be configured. The method is performed by a RAN node of the communication network. A RAN node of a communication network comprises a node that is operable to transmit, receive, process and/or orchestrate wireless signals. A RAN node may comprise a physical node and/or a virtualised network function. In some examples, a RAN node may comprise a NodeB, eNodeB, gNodeB, etc., or any other current or future implementation of such functionality.

Referring to FIG. 1, the method 100 comprises, on fulfilment of a trigger condition, causing an ML model Assurance Information (MAI) Request to be sent to the wireless device in step 110. The MAI Request comprises an indication of the ML model to which the MAI Request relates. For example, the wireless device may have multiple ML models available for performing a range of different tasks. The MAI Request may consequently indicate the ML model to which the Request relates by reference to the task performed by the ML model, the RAN operation for which its output is relevant, or in any other manner. In step 120, the method 100 comprises receiving, from the wireless device, an MAI Response, wherein the MAI Response comprises ML model characteristic information generated by the wireless device using the ML model. In step 130, the method 100 comprises configuring the RAN operation performed by the wireless device according to the received MAI Response.

A RAN operation may comprise any operation that is at least partially performed by the wireless device in the context of its connection to the Radio Access Network. For example, a RAN operation may comprise a connection operation, a mobility operation, a reporting operation, a resource configuration operation, a synchronisation operation, a traffic management operation etc. Specific examples of RAN operations may include intra or inter frequency Handover, secondary carrier prediction, localization, signal quality prediction, beam management and beam prediction, traffic prediction, Uplink synchronisation, channel state information compression, wireless signal reception/transmission, etc. Any one of more of these example operations or operation types may be configured on the basis of an output of an ML model. For example, the ML model may predict certain measurements, on the basis of which decisions for RAN operations may be taken. Such measurements may be used by the wireless device and/or provided to the RAN node performing the method. In further examples, the timing or triggering of a RAN operation may be based upon a prediction output by an ML model.

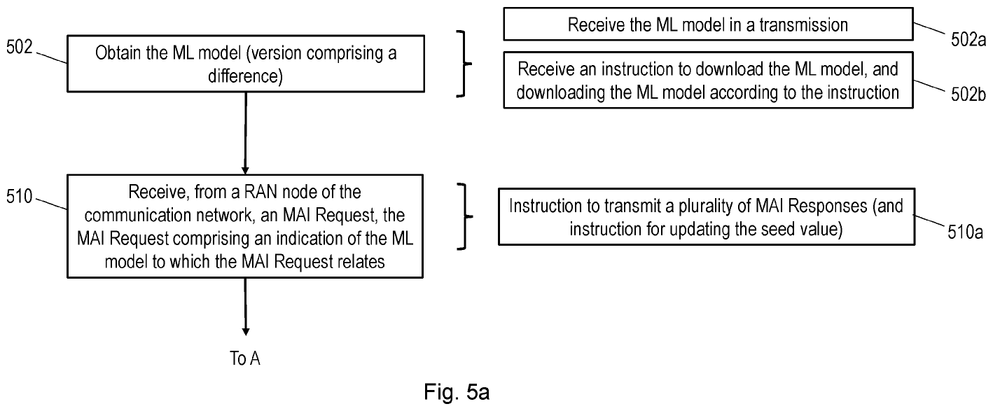

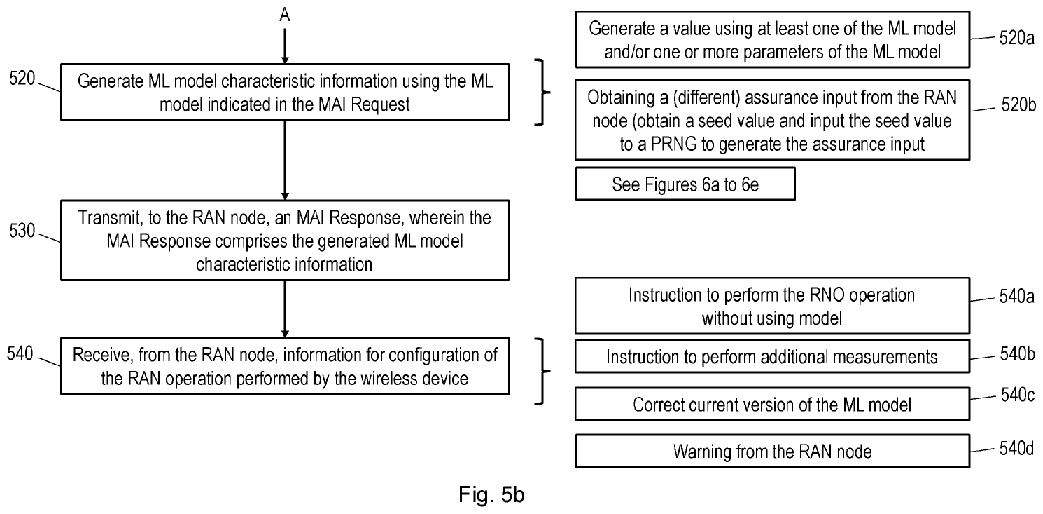

Specific examples of how the RAN node may configure the RAN operation performed by the wireless device according to the received MAI Response are discussed in detail below with reference to FIG. 5b. In general this step may comprise configuring at least one of wireless device behavior with reference to the operation or RAN node behavior with reference to the operation in a manner which is determined by the received MAI Response. The configuration may include setting values for parameters controlling the RAN operation, making selections and/or decisions with respect to the RAN operation, etc.

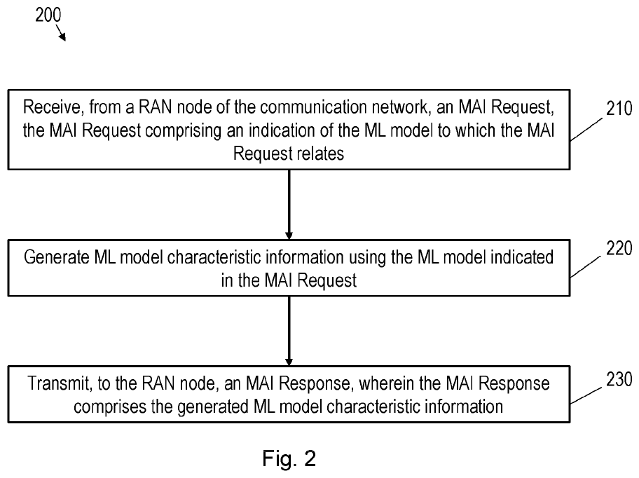

The method 100 may be complemented by a method 200 performed by a wireless device. FIG. 2 is a flow chart illustrating process steps in a method 200 for managing a wireless device that is operable to connect to a communication network, wherein the communication network comprises a Radio Access Network (RAN), and wherein the wireless device has available for execution a Machine Learning (ML) model that is operable to provide an output, on the basis of which a RAN operation performed by the wireless device may be configured. The method 200 is performed by the wireless device. Referring to FIG. 2, the method 200 comprises, receiving, from a RAN node of the communication network, an ML model Assurance Information (MAI) Request in step 210. The MAI Request comprises an indication of the ML model to which the MAI Request relates. In step 220, the method 200 comprises generating ML model characteristic information using the ML model indicated in the MAI Request. In step 230, the method 200 then comprises transmitting, to the RAN node, an MAI Response, wherein the MAI Response comprises the generated ML model characteristic information.

As discussed above, a RAN operation may comprise any operation that is at least partially performed by the wireless device in the context of its connection to the Radio Access Network. For example, a RAN operation may comprise a connection operation, a mobility operation, a reporting operation, a resource configuration operation, a synchronisation operation, a traffic management operation etc. Specific examples of RAN operations are discussed above in the context of the method 100, and below in relation to implementation examples for the methods discussed herein.

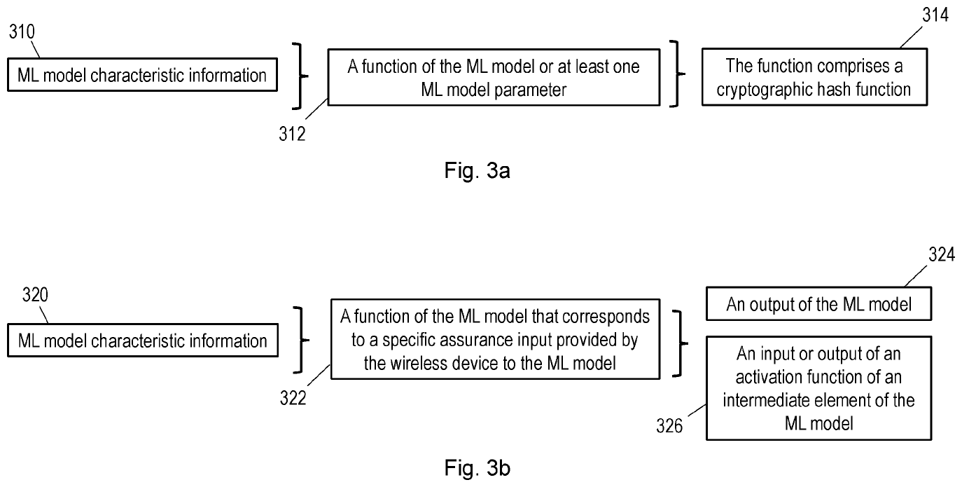

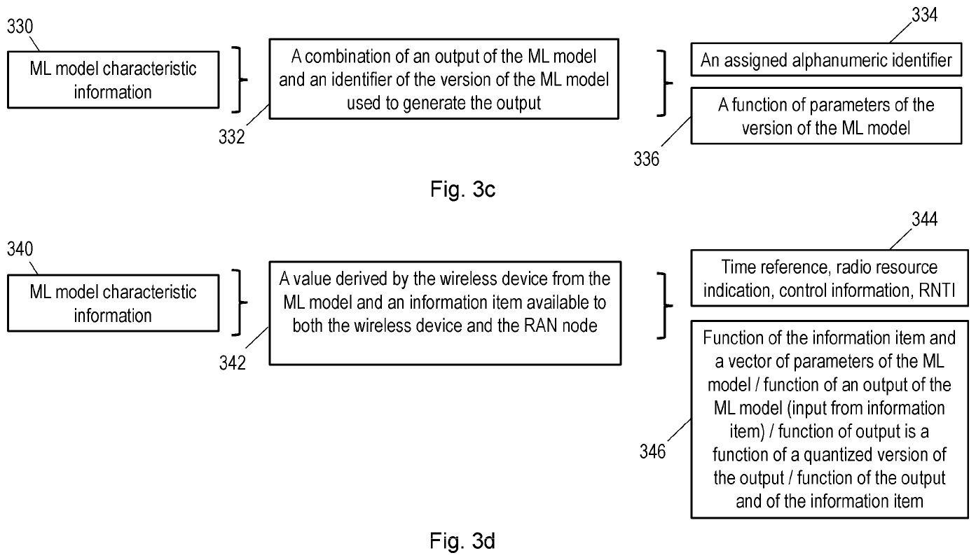

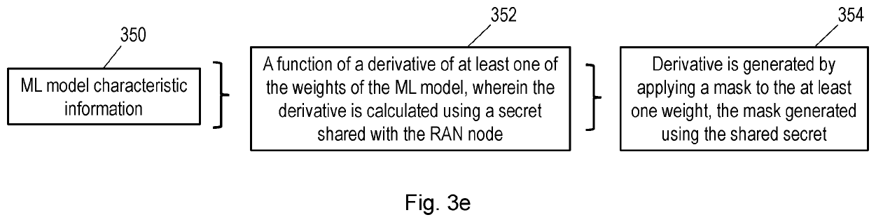

The ML model characteristic information that is generated and exchanged according to the methods 100 and 200 may take a variety of different forms. FIGS. 3a to 3e illustrate examples of different options for the ML model characteristic information of methods 100 and 200.

Referring initially to FIG. 3a, in a first example, the ML model characteristic information 310 generated by the wireless device using the ML model may comprise a function 312 of the ML model or at least one ML model parameter. As illustrated at 314, the function may comprise a cryptographic hash function. Thus in some examples, one or more trainable parameters of the ML model, or any other element, component or characterising value of the ML model, may be input to the cryptographic hash function in order to generate the ML model characteristic information. In some examples, the device may have multiple different functions, including for example different cryptographic hash functions, available for execution.

Referring now to FIG. 3b, in a second example, the ML model characteristic information 320 generated by the wireless device using the ML model may comprise, as illustrated at 322, a function of the ML model that corresponds to a specific assurance input provided by the wireless device to the ML model. The function may comprise at least one of an output of the ML model as illustrated at 324, and/or an input or output of an activation function of an intermediate element of the ML model, as illustrated at 326. The intermediate element may for example comprise a hidden layer of a Neural Network (NN), or an intermediate node of a tree model, etc. If the function comprises an input or output of an activation function, then the relevant intermediate elements (for example the specific hidden layers) to be used may be specified in the MAI Request by the RAN node.

Referring now to FIG. 3c, in a third example, the ML model characteristic information 330 generated by the wireless device using the ML model may comprise, as illustrated at 332, a combination of an output of the ML model and an identifier of the version of the ML model used to generate the output. The output may correspond to any input provided to the ML model by the wireless device, for example during the normal course of use of the ML model by the wireless device. As illustrated at 334 and 336, the identifier of the version of the ML model may comprise at least one of an assigned alphanumeric identifier and/or a function of parameters of the version of the ML model. The function may be a checksum. The combination may comprise the output of the ML model in which a number of least significant bits of the output are replaced by the identifier.

Referring now to FIG. 3d, in a fourth example, the ML model characteristic information 340 generated by the wireless device using the ML model may comprise, as illustrated at 342, a value derived by the wireless device from the ML model and an information item available to both the wireless device and the RAN node. As illustrated at 344, the information item may comprise at least one of a time reference, a radio resource indication, a control information contained in a message carrying the MAI Request, and/or a Radio Network Temporary Identifier.

As illustrated at 346, the value derived by the wireless device from the ML model and an information item available to both the wireless device and the RAN node may comprise at least one of a function of the information item and a vector of parameters of the ML model, and/or a function of an output of the ML model, which output is generated by the ML model from a model input that is generated by the wireless device using the information item. The vector of parameters could be some or all parameters of the ML model. Also as illustrated at 346, if the ML model output comprises an output in a continuous range, the function of an output of the ML model may comprise a function of a quantized version of the ML model output. In some examples, the function of an output of the ML model may comprise a function of the output of the ML model and of the information item.

Referring now to FIG. 3e, in a fifth example, the ML model characteristic information 350 generated by the wireless device using the ML model may comprise, as illustrated at 352, a function of a derivative of at least one of the weights of the ML model, wherein the derivative is calculated using a secret shared with the RAN node. As illustrated at 354, the derivative may be generated by applying a mask to the at least one weight, the mask generated using the shared secret. In some examples, applying the mask may comprise adding the mask modulo R, where R is a fixed number. The function may be a hash.

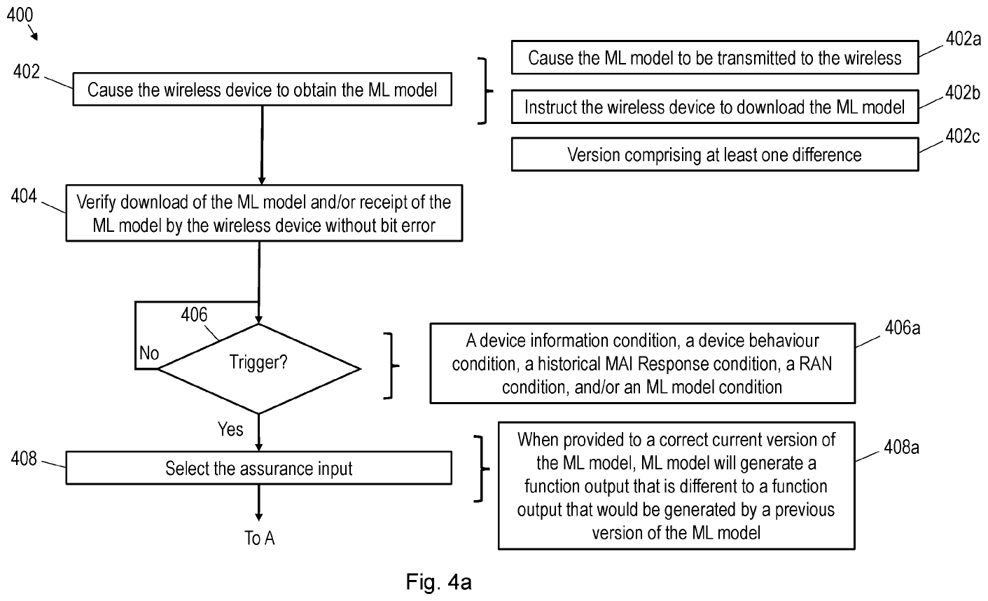

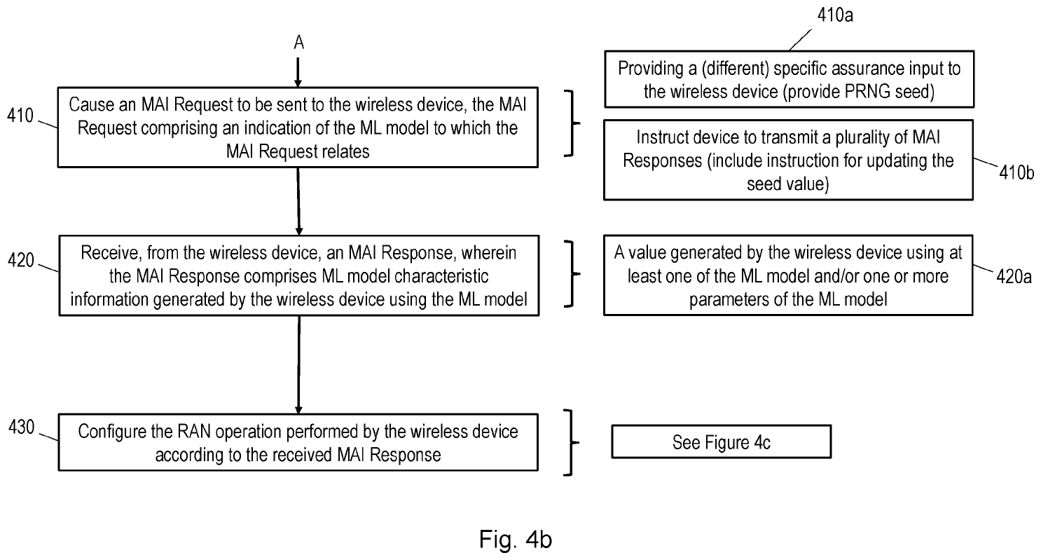

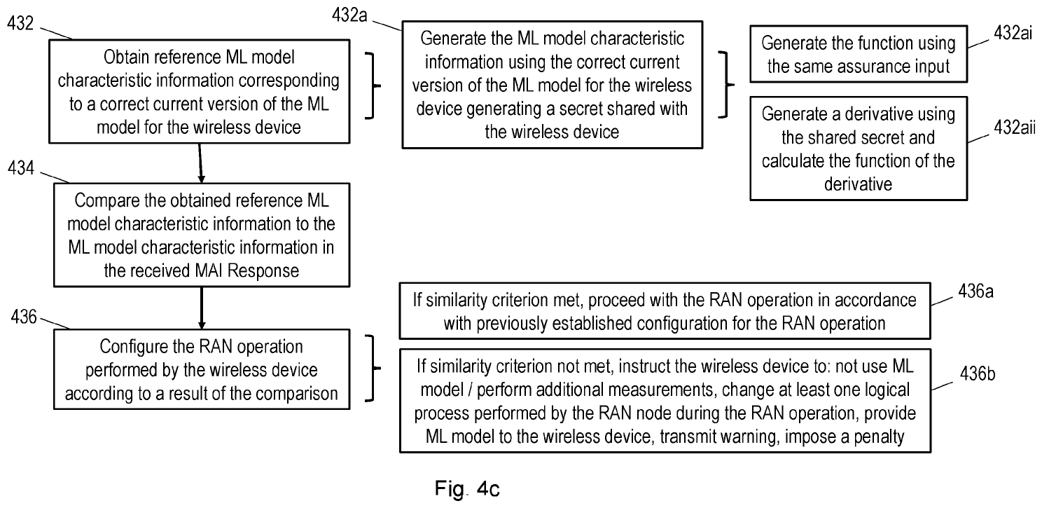

FIGS. 4a to 4c show a flow chart illustrating process steps in another example of method 400 for managing a wireless device that is operable to connect to a communication network, wherein the communication network comprises a RAN, and wherein the wireless device has available for execution an ML model that is operable to provide an output, on the basis of which a RAN operation performed by the wireless device may be configured. The method 400 may enable management of more than one wireless device, for example with the steps of the method 400 being performed with respect to multiple wireless devices. The method 400 provides various examples of how the steps of the method 100 may be implemented and supplemented to achieve the above discussed and additional functionality, and with reference to the different examples of ML model characteristic information illustrated in FIGS. 3a to 3e. As for the method 100, the method 400 is performed by a RAN node of the communication network, which may for example be a base station node such as a NodeB, eNodeB, gNodeB, etc.

Referring first to FIG. 4a, in a first step 402, the RAN node causes the wireless device to obtain an ML model by performing at least one of causing the ML model to be transmitted to the wireless device in step 402a, and/or instructing the wireless device to download the ML model from a repository using an authenticated connection in step 402b. In some examples, the ML model may be transmitted to the wireless device by the network or by another wireless device. The step 402a of causing the ML model to be transmitted to the wireless device may consequently comprise instructing or requesting a suitable entity (either a network entity or another wireless device) that is in possession of the ML model to transmit the ML model to the wireless device. Instructing the wireless device to download the ML model may comprise transmitting a message to the wireless device, the message comprising an instruction to the download the model. In some examples, the instruction to download the model may be included in an existing message transmitted from the RAN node to the wireless device in the context of any procedure or operation.

As illustrated at step 402c, the step 402 of causing the wireless device to obtain the ML model may further comprise causing the wireless device to obtain a version of the ML model that comprises at least one difference from a version of the model obtained by another wireless device, wherein the difference is such that characteristic information for the ML model will be different to characteristic information for the version of the ML model obtained by the other wireless device. The difference in the ML model version obtained by the wireless device may for example include the addition of noise to some or all ML model parameters, permutation of nodes in a manner unique to the version of the model obtained by the wireless device, etc. It is envisaged that the difference be sufficiently small as to ensure that the impact upon the ML model output is within acceptable limits for model performance, but nonetheless renders the version of the model, and specifically, the ML model characteristic information for that version, unique to the wireless device. In this manner, the wireless device is prevented from obtaining correct characterising information for an MAI Response from another wireless device.

It will be appreciated that the purpose of the difference is to render not just the ML model but its characterising information unique, and consequently the nature of the difference in the ML model may be at least partially dictated by the nature of the characterising information that will be generated by the wireless device. For example, if the wireless device will generate ML model characterising information that is based on the ML model trainable parameters (for example a hash of the parameters as in example 1 of FIG. 3a), then changing the activation functions of the ML model, while rendering the ML model unique, would not change the characterising information of the ML model, and so would not be a suitable difference. Suitable options for the difference in the ML model may follow logically from the different examples of ML model characterising information discussed with reference to FIGS. 3a to 3e.

Referring still to FIG. 4a, in step 404, the RAN node verifies at least one of download of the ML model, by the wireless device as instructed, and/or receipt of the ML model by the wireless device without bit error.

In step 406, the RAN node checks for fulfilment of a trigger condition. As illustrated at 406a, the trigger condition may take a range of different forms, including a device information condition, a device behaviour condition, a historical MAI Response condition, a RAN condition, and/or an ML model condition. Examples of such conditions are discussed below with reference to implementation detail for the methods of the present disclosure.

On fulfilment of the trigger condition, the RAN node may perform one or more steps that are specific to the particular example of ML model characteristic information to be generated by the wireless device. For example, if the ML model characteristic information is to comprise a function input or output of the ML model that corresponds to a specific assurance input provided by the wireless device to the ML model, then the RAN node may, at step 408, select the assurance input. As illustrated at 408a, the RAN node may select the assurance input such that, when the assurance input is provided to a correct current version of the ML model for the wireless device, the correct current version of the ML model will generate a function output that is different to a function output that would be generated by a previous version of the ML model. As discussed above, the function input or output of the ML model may be the output of the ML model itself, or may be inputs or outputs of hidden layer activation functions or other intermediate elements of the ML model.

It will be appreciated that in the context of the present disclosure, the “correct current version” of the ML model refers to a version of the ML model that is both correct, in that it is as provided to the wireless device and not pruned, adjusted or otherwise manipulated or containing errors, and is current in that it fulfils a validity criterion for the current time, and so has not been superseded by a later version either transmitted to the wireless device or that the wireless device has been instructed to download.

Referring now to FIG. 4b, in step 410, the RAN node causes an ML model Assurance Information (MAI) Request to be sent to the wireless device, the MAI Request comprising an indication of the ML model to which the MAI Request relates. As illustrated at 410a, this may comprise also providing the specific assurance input selected at step 408 to the wireless device. As discussed above, the assurance input provided to the wireless device may be different to an assurance input provided to another wireless device, at least within a suitable radius or other criterion, so as to avoid collaboration between wireless devices. In some examples, providing the assurance input to the wireless device at step 410a may comprise providing to the wireless device a seed value, wherein the wireless device is operable to input the seed value to a Pseudo Random Number Generator (PRNG) in order to generate the assurance input.

As illustrated at step 410b, the MAI Request may comprise an instruction to transmit a plurality of MAI Responses, and a condition for transmitting each MAI Response. The condition may be expiry of a timer for periodic sending of an MAI Response, or may be event driven, with the event comprising a RAN event, a threshold value of a parameter or KPI, or any other condition that can be monitored by the wireless device. If the RAN node has provided a seed value to the wireless device for generating an assurance input, the MAI Request may further comprise an instruction for updating the seed value to generate the ML model characteristic information for each MAI Response. The instruction may comprise an identification of a parameter whose value is to be used as the seed value, for example a timing reference.

In step 420, the RAN node receives, from the wireless device, an MAI Response, wherein the MAI Response comprises ML model characteristic information generated by the wireless device using the ML model. As discussed in more detail above and as and illustrated at 420a, the ML model characteristic information generated by the wireless device using the ML model may comprise a value generated by the wireless device using at least one of the ML model and/or one or more parameters of the ML model. The wireless device could use either or both of the model and/or its parameter, and may additionally use other information, including shared information, shared secrets, etc., as discussed above.

In step 430 of the method 400, the RAN node then configures the RAN operation performed by the wireless device according to the received MAI Response. Sub steps that may be performed in order to complete the configuration of step 430 are illustrated in FIG. 4c.

Referring now to FIG. 4c, configuring the RAN operation performed by the wireless device according to the received MAI Response may comprise, in step 432, obtaining reference ML model characteristic information corresponding to a correct current version of the ML model for the wireless device. This may comprise generating the ML model characteristic information using the correct current version of the ML model for the wireless device. The manner in which the RAN node generates the reference ML model characteristic information may vary according to the nature of the ML model characteristic information. In one example, illustrated at 432ai, the RAN node may generate the function of the correct current version of the ML model using the same specific assurance input as the wireless device. This assurance input may have been provided to the wireless device directly by the RAN node or the RAN node may generate the input using the same seed and PRNG as the wireless device. In another example, the RAN node may generate a secret shared with the wireless device, generate a derivative of at least one of the weights of the correct current version of the ML model for the wireless device using the shared secret, and calculate a function of the derivative.

In still further examples, the RAN node may determine, from a format of the ML model characteristic information, which hash function was used by the wireless device to generate the ML characteristic information so as to use the same hash function to generate the reference ML model characteristic information. Alternatively, the RAN node may try all hash functions available to the RAN node or known to be available to the wireless device. In still further examples, the RAN node may generate the ML model identifier, or obtain and using the information item in the same manner as the wireless device.

Configuring the RAN operation performed by the wireless device according to the received MAI Response may further comprise, in step 434, comparing the obtained reference ML model characteristic information to the ML model characteristic information in the received MAI Response, and, in step 436, configuring the RAN operation performed by the wireless device according to a result of the comparison.

Configuring the RAN operation performed by the wireless device according to a result of the comparison may comprise if the ML model characteristic information in the received MAI Response satisfies a similarity criterion with respect to the obtained reference ML model characteristic information, proceeding with the RAN operation performed by the wireless device in accordance with previously established configuration for the RAN operation in step 436a. If the ML model characteristic information in the received MAI Response fails to satisfy a similarity criterion with respect to the obtained reference ML model characteristic information, configuring the RAN operation may comprise performing at least one of (436b):
instructing the wireless device to perform the RNO operation without using the ML model;
instructing the wireless device to perform additional measurements;
changing at least one logical process performed by the RAN node during the RAN operation;
causing the correct current version of the ML model to be provided to the wireless device; causing a warning to be transmitted to the wireless device;
imposing a penalty on the wireless device with respect to one or more RAN operations.

Instructing the wireless device to perform the RNO operation without using the ML model, and/or to perform additional measurements may comprise transmitting a message to the wireless device, the message comprising a relevant instruction. In some examples, the instruction to perform the RNO operation without using the ML model, and/or to perform additional measurements, may be included in an existing message transmitted from the RAN node to the wireless device in the context of any procedure or operation.

Various options may be considered for the similarity criterion, including the possibility of multiple criteria to account for correct, nearly correct, and incorrect information received from the wireless device. The similarity criterion or criteria can be set according to the nature of the ML model chrematistic information, and may for example include a margin of error to allow for transmission errors.

Examples of the RAN operation that may be configured according to the methods 100 and 400 include:
beam measurement prediction;
secondary carrier prediction;
signal quality forecast;
signal quality drop prediction;
compression of radio measurements;
power control in uplink, UL, transmission;
timing advance in UL transmission;
link adaptation in UL transmission;
estimation of performance metrics;
information compression for UL transmission;
coverage estimation for secondary carrier;
estimation of signal quality degradation;
estimation of signal strength degradation;
a mobility related operation;
an energy saving operation;
a positioning operation.

FIGS. 5a and 5b show a flow chart illustrating process steps in another example of method 500 for managing a wireless device that is operable to connect to a communication network, wherein the communication network comprises a RAN, and wherein the wireless device has available for execution an ML model that is operable to provide an output, on the basis of which a RAN operation performed by the wireless device may be configured. The method 500 provides various examples of how the steps of the method 200 may be implemented and supplemented to achieve the above discussed and additional functionality. As for the method 200, the method 500 is performed by the wireless device itself.

Referring first to FIG. 5a, in a first step 502 the wireless device obtains the ML model by performing at least one of receiving the ML model in a transmission at step 502a, and/or receiving an instruction to download the ML model from a repository using an authenticated connection, and downloading the ML model according to the instruction in step 502b. The transmission may be received from the network or from another wireless device.

As illustrated at step 502, obtaining the ML model comprises obtaining a version of the ML model that comprises at least one difference from a version of the model obtained by another wireless device, wherein the difference is such that the characteristic information for the ML model will be different to characteristic information for the version of the ML model obtained by the other wireless device. This is explained in greater detail above with reference to the method 400.

In step 510, the wireless device receives, from a RAN node of the communication network, an ML model Assurance Information (MAI) Request, the MAI Request comprising an indication of the ML model to which the MAI Request relates. As illustrated at 510a, the MAI Request may comprise an instruction to transmit a plurality of MAI Responses, and a condition for transmitting each MAI Response. Also as illustrated at 510a, the MAI Request may further comprise an instruction for updating a seed value to generate the ML model characteristic information for each MAI Response. This instruction may be included if the ML model characteristic information requires use of a PRNG to generate an ML model input, as discussed above.

Referring now to FIG. 5b, in step 520, the wireless device generates ML model characteristic information using the ML model indicated in the MAI Request. As illustrated at 520a, this may comprise generating a value using at least one of the ML model and/or one or more parameters of the ML model. In certain examples, generating the ML model characteristic information may further comprise obtaining a specific assurance input from the RAN node, depending for example upon the nature of the ML model characteristic information to be generated. It will be appreciated that, as discussed above, obtaining the specific assurance input from the RAN node may comprise obtaining an assurance input that is different to an assurance input provided to another wireless device, and may comprise obtaining from the RAN node a seed value and inputting the seed value to a PRNG in order to generate the assurance input.

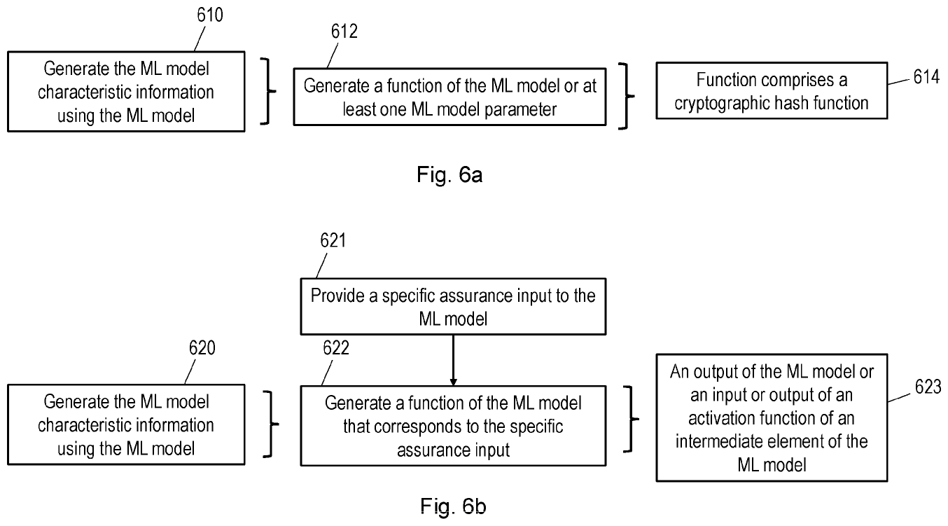

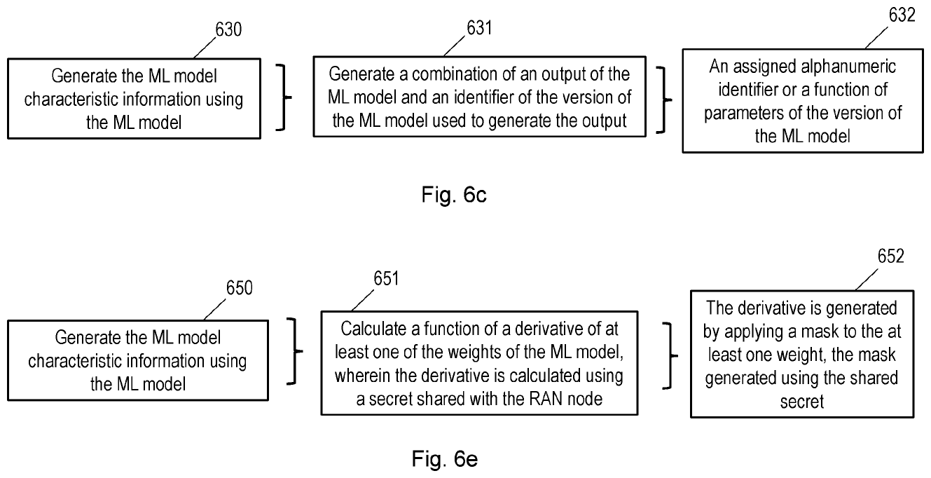

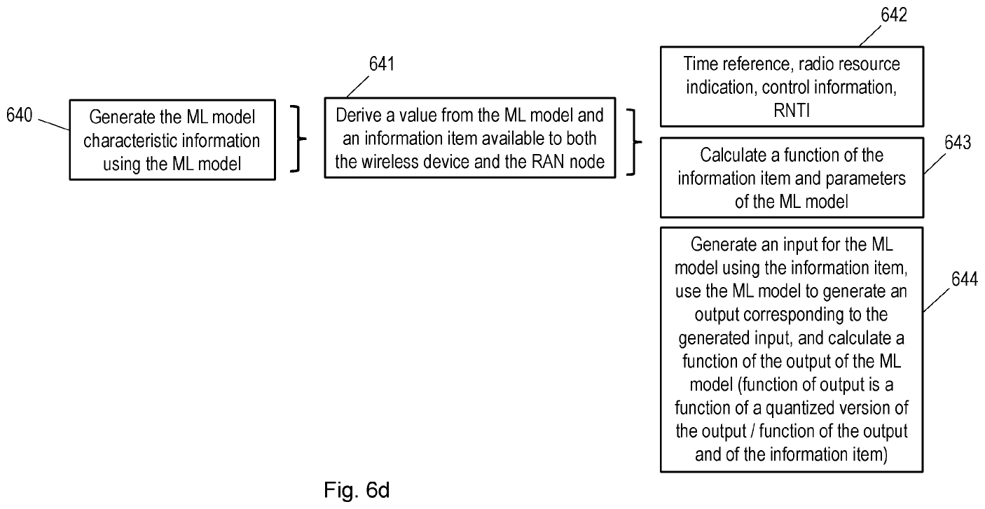

As discussed above with reference to FIGS. 3a to 3e, the ML model characteristic information that is generated by the wireless device may take a variety of different forms. FIGS. 6a to 6e illustrate examples of different sub steps that may be performed by the wireless device in order to generate different examples of the ML model characteristic information. It will be appreciated that the sub steps of FIGS. 6a to 6e discussed below may be understood in the context of the description of the different examples of ML model characteristic information provided above with reference to FIGS. 3a to 3e.

Referring initially to FIG. 6a, in a first example, the wireless device may generate the ML model characteristic information using the ML model in step 610 by generating a function of the ML model or at least one ML model parameter in step 612. As illustrated at 614, the function may comprise a cryptographic hash function.

Referring to FIG. 6b, in a second example, the wireless device may generate the ML model characteristic information using the ML model at step 620 by providing a specific assurance input to the ML model at step 621 and generating a function of the ML model at step 622 that corresponds to the specific assurance input provided by the wireless device to the ML model. As illustrated at step 623, the function may comprise at least one of an output of the ML model and/or an input or output of an activation function of an intermediate element of the ML model.

Referring to FIG. 6c, in a third example, the wireless device may generate the ML model characteristic information using the ML model at step 630 by generating on step 631 a combination of an output of the ML model and an identifier of the version of the ML model used to generate the output. As illustrated at step 632, the identifier of the version of the ML model may comprise at least one of an assigned alphanumeric identifier and/or a function of parameters of the version of the ML model.

Referring to FIG. 6d, in a fourth example, the wireless device may generate the ML model characteristic information using the ML model at step 640 by deriving, in step 641, a value from the ML model and an information item available to both the wireless device and the RAN node. As illustrated at step 642, the information item may comprise at least one of a time reference, a radio resource indication, a control information contained in a message carrying the MAI Request, and/or a Radio Network Temporary Identifier.

As illustrated in FIG. 6d, deriving a value from the ML model and an information item available to both the wireless device and the RAN node may comprise at least one of calculating a function of the information item and a vector of parameters of the ML model at step 643, and/or generating an input for the ML model using the information item, using the ML model to generate an output corresponding to the generated input, and calculating a function of the output of the ML model, in step 644. As illustrated at step 644, in some examples the ML model output may comprise an output in a continuous range, and the function of an output of the ML model may comprise a function of a quantized version of the ML model output. In some examples, the function of the output of the ML model may comprise a function of the output of the ML model and of the information item.

Referring to FIG. 6e, in a fifth example, the wireless device may generate the ML model characteristic information using the ML model at step 650 by calculating in step 651 a function of a derivative of at least one of the weights of the ML model, wherein the derivative is calculated using a secret shared with the RAN node. As illustrated at step 652, the derivative may be generated by applying a mask to the at least one weight, the mask generated using the shared secret.

Referring again to FIG. 5b, following generation of the ML model characteristic information according to any of the examples of FIGS. 6a to 6e, the wireless device then transmits, to the RAN node and in step 530, an MAI Response, wherein the MAI Response comprises the generated ML model characteristic information. In step 540, the wireless device may receive, from the RAN node, information for configuration of the RAN operation performed by the wireless device.

As illustrated in FIG. 5b, receiving, from the RAN node, information for configuration of the RAN operation performed by the wireless device may comprise receiving at least one of an instruction to perform the RNO operation without using the ML model at step 540a, an instruction to perform additional measurements at step 540b, a correct current version of the ML model for wireless device at step 540c, and/or a warning from the RAN node at step 540d. If the RAN node has been able to confirm via the MAI response that the wireless device is using the correct current version of the ML model, then the RAN nose may omit sending configuration information, and may simply proceed with the RAN operation as currently configured. However, if the MAI response transmitted by the wireless device indicates that the wireless device is not using a correct and current version of the ML model, the RAN node may send any one or more of the options illustrated at steps 540a to 540d. The RAN node may thus both configure the RAN operation to take account of the fact that the output of the ML model used by the wireless device may not be reliable (being out of date, or incorrect in some way following pruning or other manipulation), and may also attempt to ensure that the correct current version of the ML model will be used by the wireless device in future.

It will be appreciated that the methods 200 and 500 may be used in connection with the same example RAN operations as are listed above with reference to the methods 100 and 400.

As discussed above, the methods 100, 400 are performed by a RAN node, and the methods 200, 500 are performed by a wireless device, such as a UE. The present disclosure provides a RAN node and a wireless device that are adapted to perform any or all of the steps of the above discussed methods.

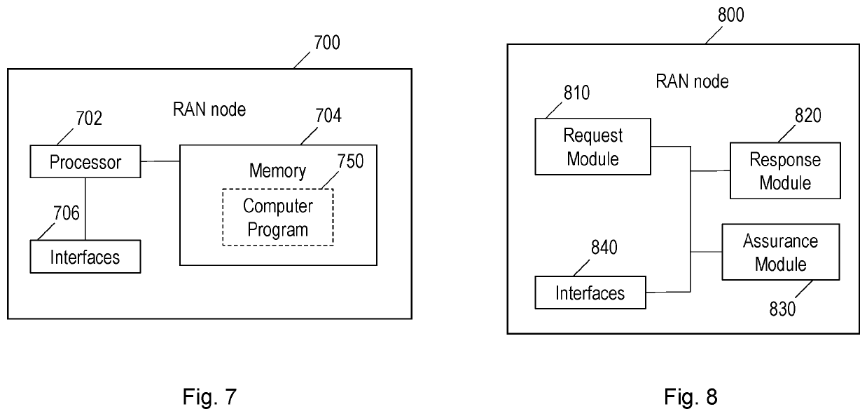

FIG. 7 is a block diagram illustrating an example RAN node 700 which may implement the method 100 and/or 400 according to examples of the present disclosure, for example on receipt of suitable instructions from a computer program 750. Referring to FIG. 7, the RAN node 700 comprises a processor or processing circuitry 702, and may comprise a memory 704 and interfaces 706. The processing circuitry 702 is operable to perform some or all of the steps of the method 100 and/or 400 as discussed above with reference to FIGS. 1, 3a to 3e, and 4a to 4c. The memory 704 may contain instructions executable by the processing circuitry 702 such that the RAN node 700 is operable to perform some or all of the steps of the method 100 and/or 400. The instructions may also include instructions for executing one or more telecommunications and/or data communications protocols. The instructions may be stored in the form of the computer program 750. In some examples, the processor or processing circuitry 702 may include one or more microprocessors or microcontrollers, as well as other digital hardware, which may include digital signal processors (DSPs), special-purpose digital logic, etc. The processor or processing circuitry 702 may be implemented by any type of integrated circuit, such as an Application Specific Integrated Circuit (ASIC), Field Programmable Gate Array (FPGA) etc. The memory 704 may include one or several types of memory suitable for the processor, such as read-only memory (ROM), random-access memory, cache memory, flash memory devices, optical storage devices, solid state disk, hard disk drive etc. The RAN node 700 may further comprise interfaces suitable for communicating with a wireless device and for communicating with other communication network nodes, according to appropriate communication protocols.

FIG. 8 illustrates functional modules in another example of RAN node 800 which may execute examples of the methods 100 and/or 400 of the present disclosure, for example according to computer readable instructions received from a computer program. It will be understood that the modules illustrated in FIG. 8 are functional modules, and may be realised in any appropriate combination of hardware and/or software. The modules may comprise one or more processors and may be integrated to any degree.

Referring to FIG. 8, the RAN node 800 is a node of a communication network comprising a RAN, and is for managing a wireless device that is operable to connect to the communication network, wherein the wireless device has available for execution an ML model that is operable to provide an output, on the basis of which a RAN operation performed by the wireless device may be configured. The RAN node comprises a Request module 810 for, on fulfilment of a trigger condition, causing an ML model Assurance Information (MAI) Request to be sent to the wireless device, the MAI Request comprising an indication of the ML model to which the MAI Request relates. The RAN node further comprises a Response module 820 for receiving, from the wireless device, an MAI Response, wherein the MAI Response comprises ML model characteristic information generated by the wireless device using the ML model. The RAN node further comprises an Assurance module 830 for configuring the RAN operation performed by the wireless device according to the received MAI Response.

The RAN node may further comprise interfaces 840 for communicating with a wireless device and for communicating with other communication network nodes, according to appropriate communication protocols.

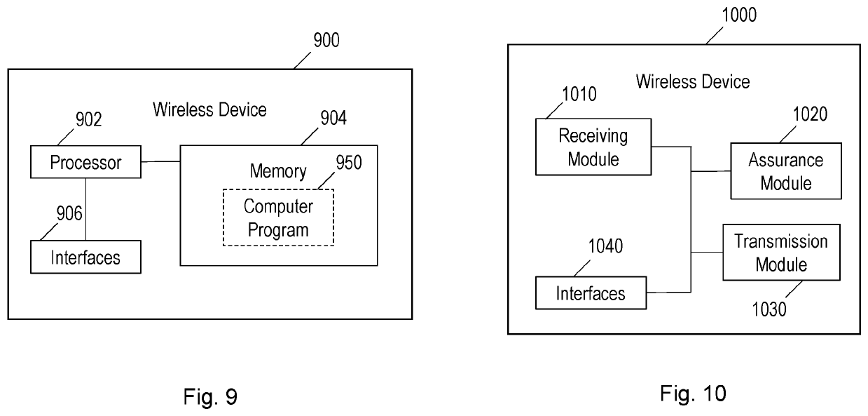

FIG. 9 is a block diagram illustrating an example wireless device 900 which may implement the method 200 and/or 500 according to examples of the present disclosure, for example on receipt of suitable instructions from a computer program 950. Referring to FIG. 9, the wireless device 900 comprises a processor or processing circuitry 902, and may comprise a memory 904 and interfaces 906. The processing circuitry 902 is operable to perform some or all of the steps of the method 200 and/or 500 as discussed above with reference to FIGS. 2, 5a and 5b, and 6a to 6e. The memory 904 may contain instructions executable by the processing circuitry 902 such that the wireless devoice 900 is operable to perform some or all of the steps of the method 200 and/or 500. The instructions may also include instructions for executing one or more telecommunications and/or data communications protocols. The instructions may be stored in the form of the computer program 950. In some examples, the processor or processing circuitry 902 may include one or more microprocessors or microcontrollers, as well as other digital hardware, which may include digital signal processors (DSPs), special-purpose digital logic, etc. The processor or processing circuitry 902 may be implemented by any type of integrated circuit, such as an Application Specific Integrated Circuit (ASIC), Field Programmable Gate Array (FPGA) etc. The memory 904 may include one or several types of memory suitable for the processor, such as read-only memory (ROM), random-access memory, cache memory, flash memory devices, optical storage devices, solid state disk, hard disk drive etc. The wireless device 900 may further comprise interfaces suitable for communicating with a RAN node according to appropriate communication protocols.

FIG. 10 illustrates functional modules in another example of wireless devoice 1000 which may execute examples of the methods 200 and/or 500 of the present disclosure, for example according to computer readable instructions received from a computer program. It will be understood that the modules illustrated in FIG. 10 are functional modules, and may be realised in any appropriate combination of hardware and/or software. The modules may comprise one or more processors and may be integrated to any degree.

Referring to FIG. 10, the wireless device 1000 is operable to connect to a communication network, wherein the communication network comprises a Radio Access Network (RAN) and wherein the wireless device has available for execution an ML model that is operable to provide an output, on the basis of which a RAN operation performed by the wireless device may be configured. The wireless device 1000 comprises a Receiving module 1010 for receiving, from a RAN node of the communication network, an ML model Assurance Information (MAI) Request, the MAI Request comprising an indication of the ML model to which the MAI Request relates. The wireless device 1000 further comprises an Assurance module 1020 for generating ML model characteristic information using the ML model indicated in the MAI Request. The wireless device 1000 further comprises a Transmission module 1030 for transmitting, to the RAN node, an MAI Response, wherein the MAI Response comprises the generated ML model characteristic information. The wireless device 1000 may further comprise interfaces 1040 suitable for communicating with a RAN node according to appropriate communication protocols.

The methods 100, 200, 400 and 500 illustrate how a RAN node and wireless device may cooperate to enable the RAN node to determine, via ML model characteristic information, whether or not an ML model is present on the device, meaning the device has access to the ML model for use in connection with a RAN operation. The characteristic information may then be used by the RAN node to configure the RAN operation accordingly, for example by compensating for information provided by the device that may have been generated using an incorrect or out of date version of the ML model. There now follows a discussion of a range of different implementation detail that may be encompassed within the above described methods. The detail presented below encompasses how the various method steps may be implemented by the RAN node and wireless device, and presentation of example use cases and deployment scenarios for the methods of the present disclosure.

As set out above, the methods proposed herein effectively enable the RAN node to evaluate the trustworthiness of an output provided by an ML model on the wireless device, and to take appropriate actions based on this evaluation. The RAN node may initially assess the wireless device itself and/or its behavior or network conditions, as part of evaluation of a trigger condition, and if appropriate, may then request an ML model Assurance Information report from the wireless device. Upon reception of the ML model Assurance Information report, which includes characteristic information for an ML model available on the wireless device, the RAN node then decides whether the device should proceed with a RAN operation using the ML model or if the ML model should be retransmitted. The RAN node can also decide to modify the RAN operation procedures to take the ML model uncertainty into account or switch to a non ML model instead.

### Provision of the ML Model to the Device (Step 402 and 404 of Method 400)

The RAN node or another network node can send the model in a unicast transmission to the device, or in a broadcast transmission (SIB) or multicast transmission, for example as disclosed in the above mentioned non-published reference internal reference. In other examples, the network may instruct the wireless device to download the ML model, or may instruct another wireless device to transmit the model to the target wireless device.

### Deciding Whether or not to Send an MAI Request (Step 406 of Method 400)

As discussed above, the RAN node may use a trigger condition to determine whether or not to request characteristic information for one or more ML models available on a wireless device. The trigger condition may take account of various factors relating to the device itself and/or the communication network, including:

1) Historical information relating to MAI Responses received from the wireless device and/or other wireless devices fulfilling a similarity criterion with respect to the wireless device or with respect to the wireless device's current location and/or behavior.

2) Information about the wireless device, including:
device manufacturer
OEM vendor
device model
chipset vendor
chipset model
device category (NR performance capability)
device class (eMBB/smartphone, IoT, RedCap, URLLC, XR, . . . )
SW version.

3) Device behavior, as particular patterns of device behavior may suggest that a wireless device should not be trusted. For example, a device that is registered as an IoT device but has a traffic pattern similar to a smartphone device may be suspect, and advice that is behaving as an airborne device (drone), while being subscribed as a regular smartphone device may also be suspect.

4) Use case information. For example, if an ML model used in a certain RNO experiences unexpected performance (e.g. predicting coverage for a certain carrier but unable to hear any cell on that carrier when the NW initiates an inter-frequency handover).

5) Periodic reports: the RAN node may decide on requesting periodic assurance reports.

6) Random reports: the RAN node may randomly select one or more devices for further inspection.

7) Provision of a new ML model: in another example the RAN node may always request the device to provide MAI whenever the RAN node signals a new model to the device.

In order to accommodate errors during normal RAN operations, the RAN node may in some examples ignore rare discrepancies. For example, if a device predicts coverage for certain carrier but cannot perform measurements on that carrier only rarely, the RAN node may allow the device to use the ML model, and if the same issue occurs more frequently, or several times consecutively, then the RAN node can decide to take appropriate action by sending an MAI Request.

### MAI Responses (Methods 400, 500)

As discussed above with particular reference to FIGS. 3a to 3e, and 6a to 6e, the ML model characteristic information that is generated by the wireless device and provided to the RAN node in the MAI response may take a range of different forms. Each of the examples introduced above is discussed in greater detail in the following disclosure.

### Example 1: Hashed Value (FIGS. 3a and 6a)

In this example the wireless device is requested to send a hashed value based on its ML model parameters. The wireless device takes the parameters of the model as input to a hashing function. The hashing function can, for example, comprise a Secure Hash Algorithm (SHA), such as SHA-3, SHA-256, etc. The wireless device then calculates the hashed value and signals it to the network (via the RAN node) in the model MAI Response message. The RAN node then compares the received hashed value with an expected response to ensure that the device has received the correct version of the ML model, and that it had not been tampered with. This is secure in the HBC trust model.

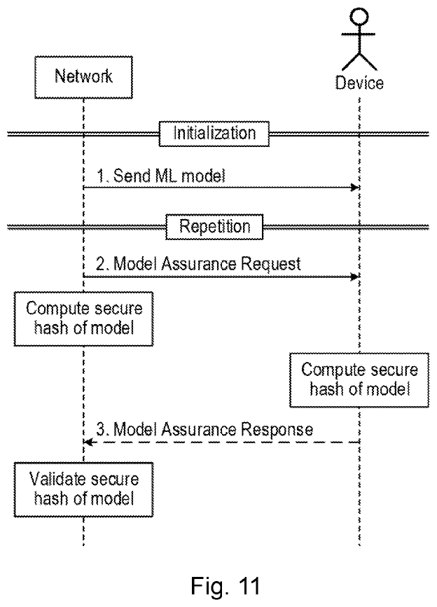

An example signaling exchange for the first example of ML model characteristic information is illustrated in FIG. 11. The communication network (via the RAN node) initially provides the ML model to the wireless device in some manner at step 1, and the network then sends an MAI Request in step 2. Both the network and the wireless device then compute a secure hash of the ML model and/or its parameters, before the wireless device sends its hash to the network in an MAI Response at step 3. The network then validates the secure hash to check that the wireless device has used the correct and current version of the ML model to generate the hash.

The RAN node may have a multitude of secure hash functions implemented, any of which may be used by the wireless device, as the network can detect and decode all of them. The wireless device may therefore select a secure hash function, hash the model weights of other parameters and send the hash to the RAN node. The RAN node can then determine the correct secure hash function form the format of the received hash and validate the secure hash. Alternatively, the RAN node may simply try all available hash functions to see if any yield the same value as that received form the wireless device.

In some examples, the RAN node may send slightly different ML models to each participating device. For example the RAN node (or another node in the communication network) may add Gaussian distributed or other noise to some or all ML model parameters before they are quantized for transmission, with mean 0 and a very small variance so that the output of the model is not changed by a significant amount. Alternatively, the RAN node or other network node may permute nodes in the model in a way that is unique to the UE but does not change the model's performance. This adaptation of the model to render it unique to the wireless device may ensure that wireless devices cannot collaborate to share characteristic information for the ML model. This is discussed in greater detail above with reference to step 402c of the method 400.

### Example 2: Model Input Data (FIGS. 3b and 6b)

In this example, the RAN node communicates a single input data sample (i.e. a row in a dataset) to the device, such as a certain combination of RSRP values for a Secondary Carrier Prediction (SCP) use case. The device then transmits as the ML model characteristic information an output generated from the ML model using the received input.

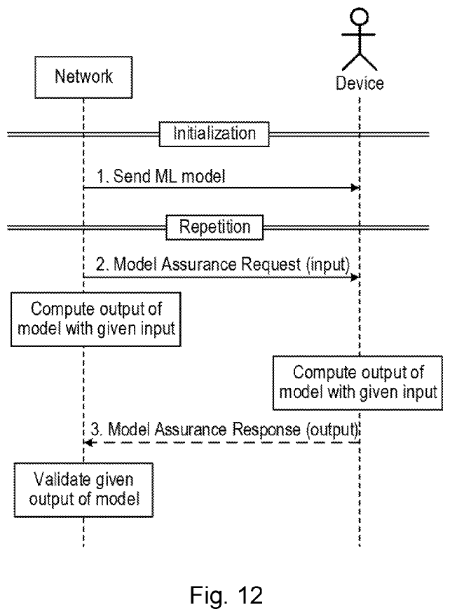

An example signaling exchange for the second example of ML model characteristic information is illustrated in FIG. 12. The communication network (via the RAN node) initially provides the ML model to the wireless device in some manner at step 1, and the network then sends an MAI Request in step 2. Both the network and the wireless device then compute an output of the ML model using the specific input, before the wireless device sends its output to the network in an MAI Response at step 3. The network then validates the received output to check that the wireless device has used the correct and current version of the ML model to generate the output.

The RAN node can select the input data to be tested based on previous models, for example selecting an input that will generate a unique output, in comparison to the models used previously for a certain RAN operation. The network may consequently keep a record of ML model versions that have previously been used by the wireless device. As discussed above with reference to step 408 of method 400, the RAN node may ensure that each device gets unique input data, so that several devices cannot collaborate by sharing the expected and correct output with each other.

In some examples, the RAN node may use a pseudo-random function to generate input data efficiently, with the wireless device having access to a pseudorandom number generator (PRNG). A sequence generated by a PRNG is not totally random but can be determined by an initial value, called the seed of the PRNG. If the RAN node sends a seed to the device, the device may use that seed to generate pseudo-random input samples X₀, X₁, . . . , X_{N}, where N (the total number of input samples) may also be a value sent by the RAN node. The MAI Request may consequently include both the seed and the value of N, where N is a positive integer.

The ML model ƒ is then evaluated by the device using the generated dataset X (X₀, X₁, . . . , X_{k=N}) and the output is signaled back to the NW in the MAI Response ƒ(Xₖ₌₀), ƒ(Xₖ₌₁), . . . , ƒ(X_{k=N}). The RAN node then compares the received values with the correct values in order to check if the model used is the correct model.

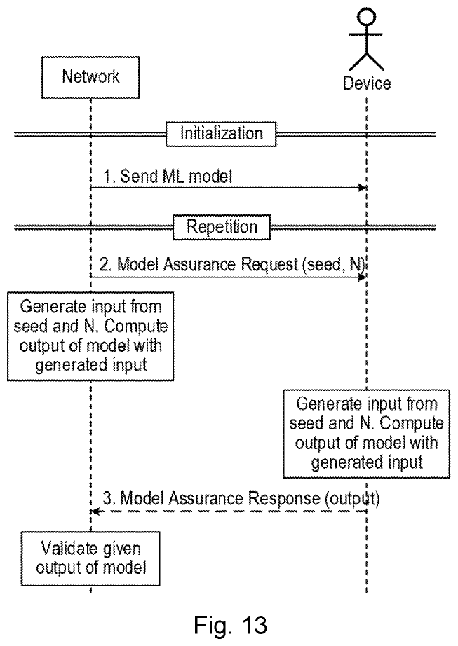

Another example signaling exchange for the second example of ML model characteristic information is illustrated in FIG. 13. The communication network (via the RAN node) initially provides the ML model to the wireless device in some manner at step 1, and the network then sends an MAI Request in step 2, the MAI Request including both the seed for the PRNG and the value N. Both the network and the wireless device then generate an input form the seed and compute an output of the ML model using the generated input, before the wireless device sends its output to the network in an MAI Response at step 3. The network then validates the received output to check that the wireless device has used the correct and current version of the ML model to generate the output.

In another variation of the present example, the characteristic information for the ML model may comprise inputs or outputs of activation functions from one or more of the intermediate elements (hidden layers of a Neural Network, intermediate nodes of a forest, etc.), with identification of the specific intermediate elements being included in the MAI Request.

In another variation, the wireless device may be configured to report the ML model output using the pseudo-random input periodically. The RAN node may indicate to the wireless device how to update the seed value for each calculation. The RAN node updates its seed value in the same manner, allowing the RAN node to check the device's output against the correct output for each MAI Response. The process of updating the seed value may use a parameter known to both the device and the RAN node, such as a timing reference.

### Example 3: Model Identifier Encoded in the Model Output (FIGS. 3c and 6c)

In another example, particularly appropriate for use cases in which the model output is directly transmitted from the device, the model identifier (ID) may be included as part of the output from the model, in the least significant bits. For example, the RAN node or another network node can add a model identifier for the least significant bits in the final layer for a neural network, or for each edge in a decision tree model. In a floating point representation, the output could be xx.xxxyyyy, where xx.xxx is the model output, and yyyy is the model ID. In this example, the characteristic information is included in the model output received for the radio network operation. For example, in case of a device reporting a predicted signal quality value, the least significant bits are replaced with the model ID in the reported predicted value.

In a variation to this example, the RAN node, or another network node, may configure the wireless device to download the ML model (with a unique ID) from a separate model repository, for example using a secure authenticated connection. This ensures that the UE downloads the model (as download can be verified by the network), and the model ID included in the output can be used to ensure that the correct model was used to generate the output. In another variation, the model identifier can be a data “checksum” generated from the model's parameters using a standardized method.

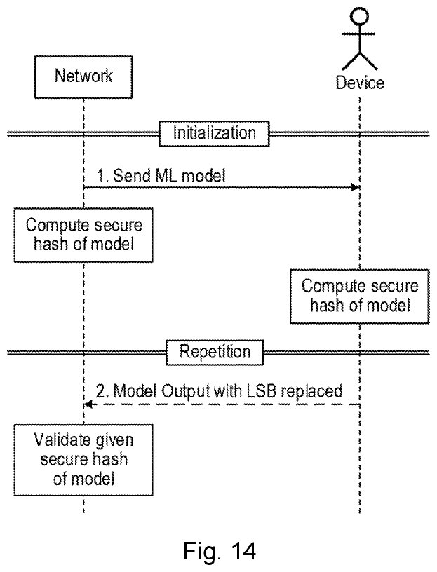

An example signaling exchange for the third example of ML model characteristic information is illustrated in FIG. 14. The communication network (via the RAN node) initially provides the ML model to the wireless device in some manner at step 1, and the network then sends an MAI Request in step 2. The device then calculates a model output and sends the output to the network at step 3, with some of the least significant bits out the output replaced by the model identifier. The network then validates the received output to check that the wireless device has used the correct and current version of the ML model to generate the output.

### Example 4: Use of Shared Information Item to Randomize Model Assurance Information (FIGS. 3d and 6d)

In this example, common knowledge in the form of an information item that is shared by the network and the wireless device is used to derive the ML model characteristic information that will be included in the MAI Response. Although the information item is shared between the device and the network, the value of the information item, referred to below as the common information (CI), can vary depending on one or more factors. The varying nature of the CI acts as a protection against misbehaving UEs (for example that may prune the model to save resources to such an extent that this has a significant impact on the model output). The larger the CI, the less motivated a device would be to misbehave. Using a CI that is shared between the RAN node and the device, this minimizes necessary information transmitted over-the-air. Example options for the CI are set out below.
1. A time reference. This may for example be related to the system frame number and/or (radio) frame and/or subframe and/or slot, and/or symbol(s) in which the assurance request is transmitted, or to another point in time, such as when the assurance response is granted for transmission. The time stamp may also relate to an absolute time reference known in the network for example using system information, see Table 1.

TABLE 1
SIB9 information in NR

SIB9 ::= SEQUENCE
{
timeInfo SEQUENCE { timeInfoUTC INTEGER (0..549755813887),
dayLightSavingTime BIT STRING (SIZE (2)) OPTIONAL,
leapSeconds INTEGER (−127..128)
}

2. A resource indication. This may for example be one or more indices related to where in the overall resource grid that the MAI Request is transmitted, or where the Response is granted. In NR such resource indication could relate to common or physical PRB indices.
3. Control information. Parts of or the whole control information received in the control message requesting the MAI Response.
4. A Radio Network Temporary Identifier (RNTI), which is used to differentiate/identify a connected mode device in the cell, or a group of devices.

The notation below is used for the different information and functionality in the following description of the present example:
w A vector of parameters that are derived from the model used
v Common information (CI)
θ The full set of parameters for the model
r The characteristic information for the MAI Response
ƒ Function that maps input of arbitrary size and of arbitrary type (e.g. real valued, binary, complex) to a binary vector response.
y=h(x;θ) The model used by the device, parameterized by the parameters in the parameter vector θ and taking a vector of input features x

Having the CI available in the device, one example for the generation of the ML model characteristic information can be described by a function ƒ that takes a model-dependent input (w) together with the CI (v) and produces an assurance response (r)

$$r = f ( w , v ) \qquad ( 1 )$$

In variations of the present example, the model-dependent input is based on a partial set of, or all model parameters (θ).

In another variation, instead of using the model parameters as the model-dependent input, input features to the model may instead be generated by a function g based on the CI (v). The output of g is then fed to the model as input.

$$y = h ( g ( v ) ; θ ) \qquad ( 2 )$$

The function generating the input features, g, may be pre-defined and is targeted to produce pseudo-random input features for a given input value.

The output of the model (y) is further processed by the function ƒ, to produce the characteristic information, i.e.:

$$r = f ( y ) \qquad ( 3 )$$

If the model output is in a continuous range, ƒ can include a quantization step in which the quantized value is converted to a vector of bits that can implicitly reflect the whether or not the deviation of the model from the true model output is acceptable. For example, if it is assumed that a device has modified the model to obtain processing and memory benefits, the model output might still be close enough to the true model such that the quantized output is the same.

In another variation of the current example, the function ƒ could also be dependent on the CI, v.

$$r = f ( y , v ) \qquad ( 4 )$$

In a simple form the use of CI could for example be in selecting which model output to quantize.

The following worked example illustrates using the CI together with model-dependent parameters, i.e. Eq. (1).

It is assumed that the CI consists of only the system frame number (SFN), which ranges from 0 to 1023, and is based on the SFN that the device receives the assurance request in. It is also assumed that the model-dependent parameters in Eq. (1) are a serialized vector of all parameters of the model, i.e. θ.

The device receives the assurance request in SFN=568 and uses it together with θ to derive r

$$r = f ( θ , 568 )$$

r is a vector of 10-bits that are sent by the device in the MAI Response.

### Example 5: Use of Shared Secrets (FIGS. 3e and 6e)

For the propose of this example, it is assumed that the RAN node and the wireless device have access to a fixed secure Pseudo Random Function Family (PRF) and a fixed secure Pseudo Random Generator (PRG) to compute pair-wise shared secrets and masks.

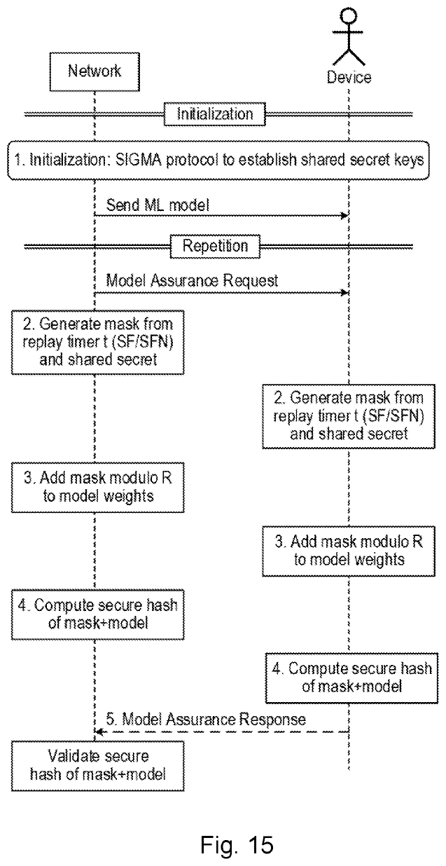

An example signaling exchange for the fifth example of ML model characteristic information is illustrated in FIG. 15. In an initialization phase, both RAN node and the wireless device use SIGMA protocol (as described at https://webee.technion.ac.il/-hugo/sigma-pdf.pdf) to generate shared secrets between the RAN node and the device in step 1. This can take place once, with new and unique masks being generated from the shared secret and a replay-timer t. Alternatively, shared secrets may be regenerated for each model assurance request. The communication network (via the RAN node) provides the ML model to the wireless device in some manner, and the network then sends an MAI Request.

In step 2, both the RAN node and the wireless device use the shared secret with a replay timer t (or SF/SFN) to generate a mask. In step 3, both the RAN node and the wireless device apply the mask to weights in the ML model (in essence a one-time pad on the weights), by adding the masks modulo R (where R is a sufficiently large number that is fixed). The RAN node and wireless device then step the relay timer. The RAN node and wireless device then, in step 4, compute a secure hash or a checksum of the model with mask applied (for example as discussed in Example 1). The device then sends the secure hash or checksum to the RAN node in an MAI Response in step 5, and the RAN node validates the received secure hash or checksum in step 6.

The above process flow enables the RAN node to establish that an entity that had access to the shared key and the replay timer and the correct model generated the checksum.

### Extensions: Accounting for Transmission Errors and Arithmetic Noise

In one possible extension, which is particularly applicable to example 2, but may also be considered for other examples, the RAN node may compute a difference A between the received response from the device and the expected response computed by the correct model (known to the RAN node). If A is less than a pre-determined threshold, the RAN node may decide that the device is using the correct model, otherwise may decide that the device is using the wrong model. The threshold A may be determined based on factors that quantify the quality of the link to the device, and its computation capabilities. For example, if the device is known to be in bad transmission conditions, a larger threshold A can be used to allow for transmission errors in the response. If the device is known to have limited computational capabilities, a larger A can be used to allow for rounding errors in its arithmetic. The use of the threshold A is thus an example of the similarity criterion discussed above with reference to steps 434 and 436 of the method 400.

### NW Actions Based on Assurance (Steps 430 to 436b of Method 400, and 540 to 540d of Method 500)

The RAN node can take a range of different actions as a consequence of the received MAI response containing the ML characteristic information. Examples of such actions are provided below:
1) Continue RNO using ML-model if case the assurance information is correct (step 436a).
2) Switch to non-ML procedure in RNO (steps 436b, 540a, 540b). For example, if the RAN node concludes that inter-frequency predictions from the device are not reliable, it may instruct the wireless device not to use the ML model, and instead configure the device with a measurement procedure for estimating the coverage on another carrier.
3) Modify the RNO based on uncertainty in the device ML-model (step 436b). The NW can also, if the ML model characteristic information is close to the expected information but not an exact match, change parameters of the RAN operation, for example:

In Secondary Carrier Prediction: If the device uses an old/modified model, it may not capture certain scenario changes such as new Base Station deployments, which can lead to less accurate predictions. The RAN node can configure the device to perform more inter-frequency measurements instead of predictions, based on the uncertainty over which model the device uses, or how it has modified the received model.

In CSI compression: When the RAN node is uncertain about how the device compressed the channel, the device can be configured with a wider beam in comparison to a beam that would have been selected as optimal, when using the decoder neural network based on the device CSI feedback.

an instruction to perform additional measurements at step 540b, a correct current version of the ML model for wireless device at step 540c, and/or a warning from the RAN node at step 540d.
4) Re-transmit model to device (steps 436b, 540c). The NW can in one example retransmit the model to the device. The RAN node can decide to send the model in a unicast transmission to the device, in which, unlike a broadcast transmission, a device is requested to acknowledge that it has received the model. However, the device can still modify the received model, and the RAN node can request assurance information in a subsequent time-step as proposed in the present disclosure.
5) Send a warning to device (steps 436b, 540d). The NW can in another example signal to the device that it detected model misuse. The device may then be offered another chance to send an updated MAI response, having corrected its behavior. If model misuse is detected, the device could also be down-prioritized in the radio resource allocation, or the RAN node could impose a delay on its transmissions as “penalty”.
   Examples of RAN Operations Executed with ML Models

Examples of operations executed by a wireless device with using an ML model may include, in addition to the examples listed in the background section, one or more operations in the group of:
power control in UL transmission
timing advance in UL transmission
Link adaptation in the UL transmission, such as selection of modulation and coding scheme
Estimation of channel quality or other performance metrics, such as
   radio channel estimation in uplink and downlink,
   channel quality indicator (CQI) estimation/selection,
   signal to noise estimation for uplink and downlink,
   signal to noise and interference estimation,
   reference signal received power (RSRP) estimation,
   reference signal received quality (RSRQ) estimation, etc.
Information compression for uplink transmission
Coverage estimation for secondary carrier
Estimation of signal quality/strength degradation
   Beam-level
   Cell-level
Mobility related operations, such as cell reselection and handover trigger
Energy saving operations
Positioning using ML methods, for example a model that translates radio measurements into a geographical location.
Compression of radio measurements, such as efficient channel state information reporting, used to improve beamforming operations or positioning estimation.

The following discussion provides additional detail relating to RAN operations in the context of which methods according to the present disclosure may be used.

Several radio network operations can be improved by AI/ML. As discuses din the background section, several use cases benefit from signaling a model that is trained at the network to the device.

### Example 1: Beam Measurement Prediction

The device can use a model to reduce its measurement related to beamforming. In NR, a device can be requested to measure on a set of CSI-RS beams. A stationary device typically experiences less variations in beam quality than a moving device. The stationary device can therefore save battery by reducing its beam measurement and instead using an ML model to predict beam strength. It can do this, for example, by measuring a subset of the beams and predicting the rest of the beams.

### Example 2: Secondary Carrier Prediction

In order to detect a node on another frequency using target carrier prediction a device is required to perform signaling of source carrier information, in which a mobile device periodically transmits source carrier information to enable a macro node to handover the device to another node operating at a higher frequency.

Using target carrier prediction, the device does not need to perform inter-frequency measurements, leading to energy savings at the device. Frequent signaling of source carrier information that enables prediction of the secondary frequency can lead to an additional overhead and should thus be minimized. However, the risk of not performing frequent periodic signaling is missing an opportunity of doing an inter-frequency handover to a less-loaded cell on another carrier.

The device can instead receive the model as described in the above mentioned non-published reference internal reference and use source carrier information as input to the model, which then triggers an output indicating coverage on the frequency-2 node at location 2. This reduces the need for frequent source carrier information signaling, while enabling the UE to predict the coverage on frequency 2 whenever its model input changes.

### Example 4: Compression of Channel State Information

Compression of CSI using auto-encoders has been proposed in WO2020/180221 for enhanced beamforming. An autoencoder is a type of neural network used to learn efficient data representations. The absolute values of the Channel impulse response (CIR) are compressed to a code, and the code is decoded to reconstruct the measured CIR. In a beamforming context, the device reports the code to the Base Station, which performs beamforming based on the decoded code (CIR).

In WO2021/177870, the methods described in WO2020/180221 are further developed for compressing the channel for improving the Observed Time Difference of Arrival (OTDOA) positioning accuracy in multipath environments. OTDOA is one of the positioning methods introduced for LTE in Release 9. The richer channel information can enable the network to test multiple hypotheses for the position estimation at the network side and increases the potential of a more accurate position estimation. In this example, the encoder part of the neural network is signaled from the network to the device.

Examples of the present disclosure thus propose a method for determining whether or not a wireless device is using the correct, current version of an ML model in the context of a certain radio network operation. On the basis of this determination, a RAN node may either proceed with the operation as configured, or may adjust configuration of the RAN operation to account for uncertainty over the version of the ML model used by the wireless device. Examples of the present disclosure thus facilitate the enforcement of more predictable device behaviors.

Particular improvements may be experienced in the following use cases:

Secondary Carrier Prediction: If the device is configured with a model that predicts values of a secondary carrier, and an MAI Response indicates that the device is not using the correct, current version of the model, the network can configure the device to perform inter-frequency measurements more frequently as its predictions are more uncertain. If the device uses an old version of the model, this may not capture certain scenario changes such as new Base Station deployments, which can lead to less accurate predictions. The network can configure the device to perform more inter-frequency measurements instead of predictions, to account for uncertainty over which version of the model the device uses, or how the device has modified the received model.

CSI compression: When the NW is uncertain about how the device compressed the channel, the device can be configured with a wider beam that that which would otherwise have been selected. This will lead to overall better beamforming selections. If the device signals a rank indicator (RI) and one or more channel quality indicators (CQIs), in addition the compressed channel, the NW can manually correct the reported RI and CQI to compensate for an incorrect ML model use (for example, drop the UE to a rank one transmission with the lowest code rate).

It will be appreciated that examples of the present disclosure may be virtualised, such that the methods and processes described herein may be run in a cloud environment.

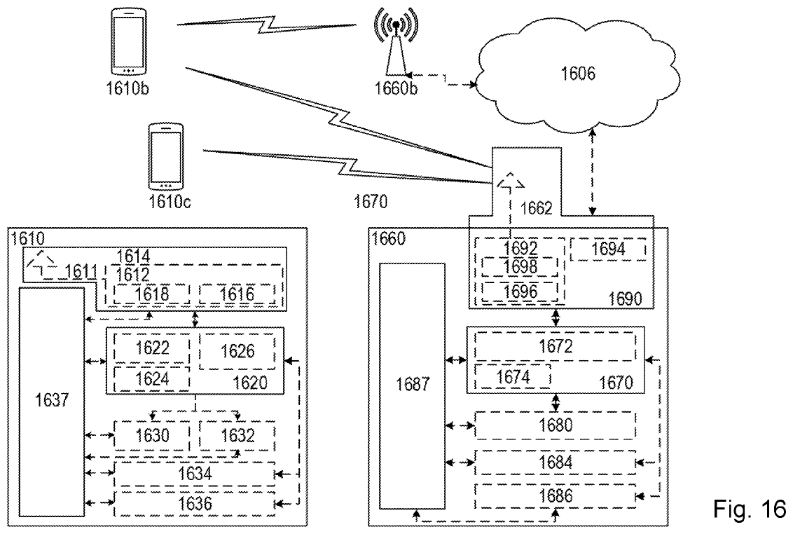

Although the subject matter described herein may be implemented in any appropriate type of system using any suitable components, the embodiments disclosed herein are described in relation to a wireless network, such as the example wireless network illustrated in FIG. 16. For simplicity, the wireless network of FIG. 16 only depicts network 1606, network nodes 1660 and 1660b, and WDs 1610, 1610b, and 1610c. In practice, a wireless network may further include any additional elements suitable to support communication between wireless devices or between a wireless device and another communication device, such as a landline telephone, a service provider, or any other network node or end device. Of the illustrated components, network node 1660 and wireless device (WD) 1610 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 1606 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 1660 and WD 1610 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 16, network node 1660 includes processing circuitry 1670, device readable medium 1680, interface 1690, auxiliary equipment 1684, power source 1686, power circuitry 1687, and antenna 1662. Although network node 1660 illustrated in the example wireless network of FIG. 16 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 1660 are depicted as single boxes located within a larger box, or nested within multiple boxes, in practice, a network node may comprise multiple different physical components that make up a single illustrated component (e.g., device readable medium 1680 may comprise multiple separate hard drives as well as multiple RAM modules).

Similarly, network node 1660 may be composed of multiple physically separate components (e.g., a NodeB component and a RNC component, or a BTS component and a BSC component, etc.), which may each have their own respective components. In certain scenarios in which network node 1660 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 1660 may be configured to support multiple radio access technologies (RATs). In such embodiments, some components may be duplicated (e.g., separate device readable medium 1680 for the different RATs) and some components may be reused (e.g., the same antenna 1662 may be shared by the RATs). Network node 1660 may also include multiple sets of the various illustrated components for different wireless technologies integrated into network node 1660, such as, for example, GSM, WCDMA, LTE, NR, WiFi, or Bluetooth wireless technologies. These wireless technologies may be integrated into the same or different chip or set of chips and other components within network node 1660.

Processing circuitry 1670 is configured to perform any determining, calculating, or similar operations (e.g., certain obtaining operations) described herein as being provided by a network node. These operations performed by processing circuitry 1670 may include processing information obtained by processing circuitry 1670 by, for example, converting the obtained information into other information, comparing the obtained information or converted information to information stored in the network node, and/or performing one or more operations based on the obtained information or converted information, and as a result of said processing making a determination.

Processing circuitry 1670 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1660 components, such as device readable medium 1680, network node 1660 functionality. For example, processing circuitry 1670 may execute instructions stored in device readable medium 1680 or in memory within processing circuitry 1670. Such functionality may include providing any of the various wireless features, functions, or benefits discussed herein. In some embodiments, processing circuitry 1670 may include a system on a chip (SOC).

In some embodiments, processing circuitry 1670 may include one or more of radio frequency (RF) transceiver circuitry 1672 and baseband processing circuitry 1674. In some embodiments, radio frequency (RF) transceiver circuitry 1672 and baseband processing circuitry 1674 may be on separate chips (or sets of chips), boards, or units, such as radio units and digital units. In alternative embodiments, part or all of RF transceiver circuitry 1672 and baseband processing circuitry 1674 may be on the same chip or set of chips, boards, or units.

In certain embodiments, some or all of the functionality described herein as being provided by a network node, base station, eNB or other such network device may be performed by processing circuitry 1670 executing instructions stored on device readable medium 1680 or memory within processing circuitry 1670. In alternative embodiments, some or all of the functionality may be provided by processing circuitry 1670 without executing instructions stored on a separate or discrete device readable medium, such as in a hard-wired manner. In any of those embodiments, whether executing instructions stored on a device readable storage medium or not, processing circuitry 1670 can be configured to perform the described functionality. The benefits provided by such functionality are not limited to processing circuitry 1670 alone or to other components of network node 1660, but are enjoyed by network node 1660 as a whole, and/or by end users and the wireless network generally.

Device readable medium 1680 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 1670. Device readable medium 1680 may store any suitable instructions, data or information, including a computer program, software, an application including one or more of logic, rules, code, tables, etc. and/or other instructions capable of being executed by processing circuitry 1670 and, utilized by network node 1660. Device readable medium 1680 may be used to store any calculations made by processing circuitry 1670 and/or any data received via interface 1690. In some embodiments, processing circuitry 1670 and device readable medium 1680 may be considered to be integrated.

Interface 1690 is used in the wired or wireless communication of signalling and/or data between network node 1660, network 1606, and/or WDs 1610. As illustrated, interface 1690 comprises port(s)/terminal(s) 1694 to send and receive data, for example to and from network 1606 over a wired connection. Interface 1690 also includes radio front end circuitry 1692 that may be coupled to, or in certain embodiments a part of, antenna 1662. Radio front end circuitry 1692 comprises filters 1698 and amplifiers 1696. Radio front end circuitry 1692 may be connected to antenna 1662 and processing circuitry 1670. Radio front end circuitry may be configured to condition signals communicated between antenna 1662 and processing circuitry 1670. Radio front end circuitry 1692 may receive digital data that is to be sent out to other network nodes or WDs via a wireless connection. Radio front end circuitry 1692 may convert the digital data into a radio signal having the appropriate channel and bandwidth parameters using a combination of filters 1698 and/or amplifiers 1696. The radio signal may then be transmitted via antenna 1662. Similarly, when receiving data, antenna 1662 may collect radio signals which are then converted into digital data by radio front end circuitry 1692. The digital data may be passed to processing circuitry 1670. In other embodiments, the interface may comprise different components and/or different combinations of components.

In certain alternative embodiments, network node 1660 may not include separate radio front end circuitry 1692, instead, processing circuitry 1670 may comprise radio front end circuitry and may be connected to antenna 1662 without separate radio front end circuitry 1692. Similarly, in some embodiments, all or some of RF transceiver circuitry 1672 may be considered a part of interface 1690. In still other embodiments, interface 1690 may include one or more ports or terminals 1694, radio front end circuitry 1692, and RF transceiver circuitry 1672, as part of a radio unit (not shown), and interface 1690 may communicate with baseband processing circuitry 1674, which is part of a digital unit (not shown).

Antenna 1662 may include one or more antennas, or antenna arrays, configured to send and/or receive wireless signals. Antenna 1662 may be coupled to radio front end circuitry 1690 and may be any type of antenna capable of transmitting and receiving data and/or signals wirelessly. In some embodiments, antenna 1662 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 1662 may be separate from network node 1660 and may be connectable to network node 1660 through an interface or port.

Antenna 1662, interface 1690, and/or processing circuitry 1670 may be configured to perform any receiving operations and/or certain obtaining operations described herein as being performed by a network node. Any information, data and/or signals may be received from a wireless device, another network node and/or any other network equipment. Similarly, antenna 1662, interface 1690, and/or processing circuitry 1670 may be configured to perform any transmitting operations described herein as being performed by a network node. Any information, data and/or signals may be transmitted to a wireless device, another network node and/or any other network equipment.

Power circuitry 1687 may comprise, or be coupled to, power management circuitry and is configured to supply the components of network node 1660 with power for performing the functionality described herein. Power circuitry 1687 may receive power from power source 1686. Power source 1686 and/or power circuitry 1687 may be configured to provide power to the various components of network node 1660 in a form suitable for the respective components (e.g., at a voltage and current level needed for each respective component). Power source 1686 may either be included in, or external to, power circuitry 1687 and/or network node 1660. For example, network node 1660 may be connectable to an external power source (e.g., an electricity outlet) via an input circuitry or interface such as an electrical cable, whereby the external power source supplies power to power circuitry 1687. As a further example, power source 1686 may comprise a source of power in the form of a battery or battery pack which is connected to, or integrated in, power circuitry 1687. The battery may provide backup power should the external power source fail. Other types of power sources, such as photovoltaic devices, may also be used.

Alternative embodiments of network node 1660 may include additional components beyond those shown in FIG. 16 that may be responsible for providing certain aspects of the network node's functionality, including any of the functionality described herein and/or any functionality necessary to support the subject matter described herein. For example, network node 1660 may include user interface equipment to allow input of information into network node 1660 and to allow output of information from network node 1660. This may allow a user to perform diagnostic, maintenance, repair, and other administrative functions for network node 1660.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. AWD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 1610 includes antenna 1611, interface 1614, processing circuitry 1620, device readable medium 1630, user interface equipment 1632, auxiliary equipment 1634, power source 1636 and power circuitry 1637. WD 1610 may include multiple sets of one or more of the illustrated components for different wireless technologies supported by WD 1610, such as, for example, GSM, WCDMA, LTE, NR, WiFi, WiMAX, or Bluetooth wireless technologies, just to mention a few. These wireless technologies may be integrated into the same or different chips or set of chips as other components within WD 1610.

Antenna 1611 may include one or more antennas or antenna arrays, configured to send and/or receive wireless signals, and is connected to interface 1614. In certain alternative embodiments, antenna 1611 may be separate from WD 1610 and be connectable to WD 1610 through an interface or port. Antenna 1611, interface 1614, and/or processing circuitry 1620 may be configured to perform any receiving or transmitting operations described herein as being performed by a WD. Any information, data and/or signals may be received from a network node and/or another WD. In some embodiments, radio front end circuitry and/or antenna 1611 may be considered an interface.

As illustrated, interface 1614 comprises radio front end circuitry 1612 and antenna 1611. Radio front end circuitry 1612 comprise one or more filters 1618 and amplifiers 1616. Radio front end circuitry 1614 is connected to antenna 1611 and processing circuitry 1620, and is configured to condition signals communicated between antenna 1611 and processing circuitry 1620. Radio front end circuitry 1612 may be coupled to or a part of antenna 1611. In some embodiments, WD 1610 may not include separate radio front end circuitry 1612; rather, processing circuitry 1620 may comprise radio front end circuitry and may be connected to antenna 1611. Similarly, in some embodiments, some or all of RF transceiver circuitry 1622 may be considered a part of interface 1614. Radio front end circuitry 1612 may receive digital data that is to be sent out to other network nodes or WDs via a wireless connection. Radio front end circuitry 1612 may convert the digital data into a radio signal having the appropriate channel and bandwidth parameters using a combination of filters 1618 and/or amplifiers 1616. The radio signal may then be transmitted via antenna 1611. Similarly, when receiving data, antenna 1611 may collect radio signals which are then converted into digital data by radio front end circuitry 1612. The digital data may be passed to processing circuitry 1620. In other embodiments, the interface may comprise different components and/or different combinations of components.

Processing circuitry 1620 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 1610 components, such as device readable medium 1630, WD 1610 functionality. Such functionality may include providing any of the various wireless features or benefits discussed herein. For example, processing circuitry 1620 may execute instructions stored in device readable medium 1630 or in memory within processing circuitry 1620 to provide the functionality disclosed herein.

As illustrated, processing circuitry 1620 includes one or more of RF transceiver circuitry 1622, baseband processing circuitry 1624, and application processing circuitry 1626. In other embodiments, the processing circuitry may comprise different components and/or different combinations of components. In certain embodiments processing circuitry 1620 of WD 1610 may comprise a SOC. In some embodiments, RF transceiver circuitry 1622, baseband processing circuitry 1624, and application processing circuitry 1626 may be on separate chips or sets of chips. In alternative embodiments, part or all of baseband processing circuitry 1624 and application processing circuitry 1626 may be combined into one chip or set of chips, and RF transceiver circuitry 1622 may be on a separate chip or set of chips. In still alternative embodiments, part or all of RF transceiver circuitry 1622 and baseband processing circuitry 1624 may be on the same chip or set of chips, and application processing circuitry 1626 may be on a separate chip or set of chips. In yet other alternative embodiments, part or all of RF transceiver circuitry 1622, baseband processing circuitry 1624, and application processing circuitry 1626 may be combined in the same chip or set of chips. In some embodiments, RF transceiver circuitry 1622 may be a part of interface 1614. RF transceiver circuitry 1622 may condition RF signals for processing circuitry 1620.

In certain embodiments, some or all of the functionality described herein as being performed by a WD may be provided by processing circuitry 1620 executing instructions stored on device readable medium 1630, which in certain embodiments may be a computer-readable storage medium. In alternative embodiments, some or all of the functionality may be provided by processing circuitry 1620 without executing instructions stored on a separate or discrete device readable storage medium, such as in a hard-wired manner. In any of those particular embodiments, whether executing instructions stored on a device readable storage medium or not, processing circuitry 1620 can be configured to perform the described functionality. The benefits provided by such functionality are not limited to processing circuitry 1620 alone or to other components of WD 1610, but are enjoyed by WD 1610 as a whole, and/or by end users and the wireless network generally.

Processing circuitry 1620 may be configured to perform any determining, calculating, or similar operations (e.g., certain obtaining operations) described herein as being performed by a WD. These operations, as performed by processing circuitry 1620, may include processing information obtained by processing circuitry 1620 by, for example, converting the obtained information into other information, comparing the obtained information or converted information to information stored by WD 1610, and/or performing one or more operations based on the obtained information or converted information, and as a result of said processing making a determination.

Device readable medium 1630 may be operable to store a computer program, software, an application including one or more of logic, rules, code, tables, etc. and/or other instructions capable of being executed by processing circuitry 1620. Device readable medium 1630 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 1620. In some embodiments, processing circuitry 1620 and device readable medium 1630 may be considered to be integrated.

User interface equipment 1632 may provide components that allow for a human user to interact with WD 1610. Such interaction may be of many forms, such as visual, audial, tactile, etc. User interface equipment 1632 may be operable to produce output to the user and to allow the user to provide input to WD 1610. The type of interaction may vary depending on the type of user interface equipment 1632 installed in WD 1610. For example, if WD 1610 is a smart phone, the interaction may be via a touch screen; if WD 1610 is a smart meter, the interaction may be through a screen that provides usage (e.g., the number of gallons used) or a speaker that provides an audible alert (e.g., if smoke is detected). User interface equipment 1632 may include input interfaces, devices and circuits, and output interfaces, devices and circuits. User interface equipment 1632 is configured to allow input of information into WD 1610, and is connected to processing circuitry 1620 to allow processing circuitry 1620 to process the input information. User interface equipment 1632 may include, for example, a microphone, a proximity or other sensor, keys/buttons, a touch display, one or more cameras, a USB port, or other input circuitry. User interface equipment 1632 is also configured to allow output of information from WD 1610, and to allow processing circuitry 1620 to output information from WD 1610. User interface equipment 1632 may include, for example, a speaker, a display, vibrating circuitry, a USB port, a headphone interface, or other output circuitry. Using one or more input and output interfaces, devices, and circuits, of user interface equipment 1632, WD 1610 may communicate with end users and/or the wireless network, and allow them to benefit from the functionality described herein.

Auxiliary equipment 1634 is operable to provide more specific functionality which may not be generally performed by WDs. This may comprise specialized sensors for doing measurements for various purposes, interfaces for additional types of communication such as wired communications etc. The inclusion and type of components of auxiliary equipment 1634 may vary depending on the embodiment and/or scenario.

Power source 1636 may, in some embodiments, be in the form of a battery or battery pack. Other types of power sources, such as an external power source (e.g., an electricity outlet), photovoltaic devices or power cells, may also be used. WD 1610 may further comprise power circuitry 1637 for delivering power from power source 1636 to the various parts of WD 1610 which need power from power source 1636 to carry out any functionality described or indicated herein. Power circuitry 1637 may in certain embodiments comprise power management circuitry. Power circuitry 1637 may additionally or alternatively be operable to receive power from an external power source; in which case WD 1610 may be connectable to the external power source (such as an electricity outlet) via input circuitry or an interface such as an electrical power cable. Power circuitry 1637 may also in certain embodiments be operable to deliver power from an external power source to power source 1636. This may be, for example, for the charging of power source 1636. Power circuitry 1637 may perform any formatting, converting, or other modification to the power from power source 1636 to make the power suitable for the respective components of WD 1610 to which power is supplied.

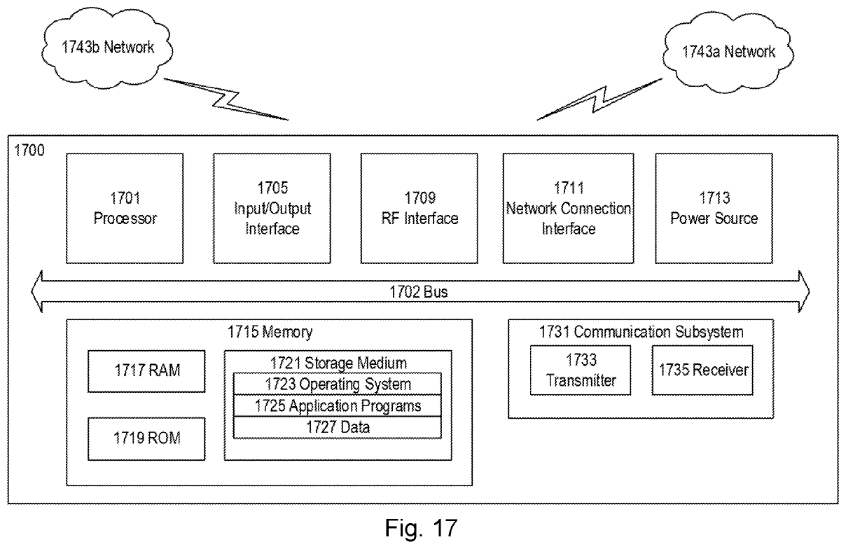

FIG. 17 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 1700 may be any UE identified by the 3rd Generation Partnership Project (3GPP), including a NB-IoT UE, a machine type communication (MTC) UE, and/or an enhanced MTC (eMTC) UE. UE 1700, as illustrated in FIG. 17, is one example of a WD configured for communication in accordance with one or more communication standards promulgated by the 3rd Generation Partnership Project (3GPP), such as 3GPP's GSM, UMTS, LTE, and/or 5G standards. As mentioned previously, the term WD and UE may be used interchangeable. Accordingly, although FIG. 17 is a UE, the components discussed herein are equally applicable to a WD, and vice-versa.

In FIG. 17, UE 1700 includes processing circuitry 1701 that is operatively coupled to input/output interface 1705, radio frequency (RF) interface 1709, network connection interface 1711, memory 1715 including random access memory (RAM) 1717, read-only memory (ROM) 1719, and storage medium 1721 or the like, communication subsystem 1731, power source 1733, and/or any other component, or any combination thereof. Storage medium 1721 includes operating system 1723, application program 1725, and data 1727. In other embodiments, storage medium 1721 may include other similar types of information. Certain UEs may utilize all of the components shown in FIG. 17, or only a subset of the components. The level of integration between the components may vary from one UE to another UE. Further, certain UEs may contain multiple instances of a component, such as multiple processors, memories, transceivers, transmitters, receivers, etc.

In FIG. 17, processing circuitry 1701 may be configured to process computer instructions and data. Processing circuitry 1701 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 1701 may include two central processing units (CPUs). Data may be information in a form suitable for use by a computer.

In the depicted embodiment, input/output interface 1705 may be configured to provide a communication interface to an input device, output device, or input and output device. UE 1700 may be configured to use an output device via input/output interface 1705. An output device may use the same type of interface port as an input device. For example, a USB port may be used to provide input to and output from UE 1700. The output device may be a speaker, a sound card, a video card, a display, a monitor, a printer, an actuator, an emitter, a smartcard, another output device, or any combination thereof. UE 1700 may be configured to use an input device via input/output interface 1705 to allow a user to capture information into UE 1700. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 17, RF interface 1709 may be configured to provide a communication interface to RF components such as a transmitter, a receiver, and an antenna. Network connection interface 1711 may be configured to provide a communication interface to network 1743a. Network 1743a may encompass wired and/or wireless networks such as a local-area network (LAN), a wide-area network (WAN), a computer network, a wireless network, a telecommunications network, another like network or any combination thereof. For example, network 1743a may comprise a Wi-Fi network. Network connection interface 1711 may be configured to include a receiver and a transmitter interface used to communicate with one or more other devices over a communication network according to one or more communication protocols, such as Ethernet, TCP/IP, SONET, ATM, or the like. Network connection interface 1711 may implement receiver and transmitter functionality appropriate to the communication network links (e.g., optical, electrical, and the like). The transmitter and receiver functions may share circuit components, software or firmware, or alternatively may be implemented separately.

RAM 1717 may be configured to interface via bus 1702 to processing circuitry 1701 to provide storage or caching of data or computer instructions during the execution of software programs such as the operating system, application programs, and device drivers. ROM 1719 may be configured to provide computer instructions or data to processing circuitry 1701. For example, ROM 1719 may be configured to store invariant low-level system code or data for basic system functions such as basic input and output (I/O), startup, or reception of keystrokes from a keyboard that are stored in a non-volatile memory. Storage medium 1721 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 1721 may be configured to include operating system 1723, application program 1725 such as a web browser application, a widget or gadget engine or another application, and data file 1727. Storage medium 1721 may store, for use by UE 1700, any of a variety of various operating systems or combinations of operating systems.

Storage medium 1721 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 1721 may allow UE 1700 to access computer-executable instructions, application programs or the like, stored on transitory or non-transitory memory media, to off-load data, or to upload data. An article of manufacture, such as one utilizing a communication system may be tangibly embodied in storage medium 1721, which may comprise a device readable medium.

In FIG. 17, processing circuitry 1701 may be configured to communicate with network 1743b using communication subsystem 1731. Network 1743a and network 1743b may be the same network or networks or different network or networks. Communication subsystem 1731 may be configured to include one or more transceivers used to communicate with network 1743b. For example, communication subsystem 1731 may be configured to include one or more transceivers used to communicate with one or more remote transceivers of another device capable of wireless communication such as another WD, UE, or base station of a radio access network (RAN) according to one or more communication protocols, such as IEEE 802.11 CDMA, WCDMA, GSM, LTE, UTRAN, WiMax, or the like. Each transceiver may include transmitter 1733 and/or receiver 1735 to implement transmitter or receiver functionality, respectively, appropriate to the RAN links (e.g., frequency allocations and the like). Further, transmitter 1733 and receiver 1735 of each transceiver may share circuit components, software or firmware, or alternatively may be implemented separately.

In the illustrated embodiment, the communication functions of communication subsystem 1731 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 1731 may include cellular communication, Wi-Fi communication, Bluetooth communication, and GPS communication. Network 1743b may encompass wired and/or wireless networks such as a local-area network (LAN), a wide-area network (WAN), a computer network, a wireless network, a telecommunications network, another like network or any combination thereof. For example, network 1743b may be a cellular network, a Wi-Fi network, and/or a near-field network. Power source 1713 may be configured to provide alternating current (AC) or direct current (DC) power to components of UE 1700.

The features, benefits and/or functions described herein may be implemented in one of the components of UE 1700 or partitioned across multiple components of UE 1700. Further, the features, benefits, and/or functions described herein may be implemented in any combination of hardware, software or firmware. In one example, communication subsystem 1731 may be configured to include any of the components described herein. Further, processing circuitry 1701 may be configured to communicate with any of such components over bus 1702. In another example, any of such components may be represented by program instructions stored in memory that when executed by processing circuitry 1701 perform the corresponding functions described herein. In another example, the functionality of any of such components may be partitioned between processing circuitry 1701 and communication subsystem 1731. In another example, the non-computationally intensive functions of any of such components may be implemented in software or firmware and the computationally intensive functions may be implemented in hardware.

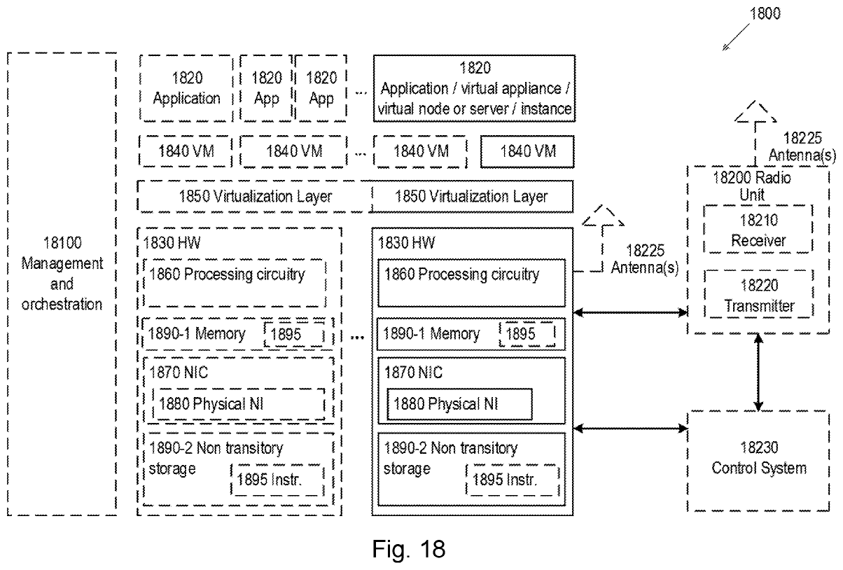

FIG. 18 is a schematic block diagram illustrating a virtualization environment 1800 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 1800 hosted by one or more of hardware nodes 1830. Further, in embodiments in which the virtual node is not a radio access node or does not require radio connectivity (e.g., a core network node), then the network node may be entirely virtualized.

The functions may be implemented by one or more applications 1820 (which may alternatively be called software instances, virtual appliances, network functions, virtual nodes, virtual network functions, etc.) operative to implement some of the features, functions, and/or benefits of some of the embodiments disclosed herein. Applications 1820 are run in virtualization environment 1800 which provides hardware 1830 comprising processing circuitry 1860 and memory 1890. Memory 1890 contains instructions 1895 executable by processing circuitry 1860 whereby application 1820 is operative to provide one or more of the features, benefits, and/or functions disclosed herein.

Virtualization environment 1800, comprises general-purpose or special-purpose network hardware devices 1830 comprising a set of one or more processors or processing circuitry 1860, which may be commercial off-the-shelf (COTS) processors, dedicated Application Specific Integrated Circuits (ASICs), or any other type of processing circuitry including digital or analog hardware components or special purpose processors. Each hardware device may comprise memory 1890-1 which may be non-persistent memory for temporarily storing instructions 1895 or software executed by processing circuitry 1860. Each hardware device may comprise one or more network interface controllers (NICs) 1870, also known as network interface cards, which include physical network interface 1880. Each hardware device may also include non-transitory, persistent, machine-readable storage media 1890-2 having stored therein software 1895 and/or instructions executable by processing circuitry 1860. Software 1895 may include any type of software including software for instantiating one or more virtualization layers 1850 (also referred to as hypervisors), software to execute virtual machines 1840 as well as software allowing it to execute functions, features and/or benefits described in relation with some embodiments described herein.

Virtual machines 1840, comprise virtual processing, virtual memory, virtual networking or interface and virtual storage, and may be run by a corresponding virtualization layer 1850 or hypervisor. Different embodiments of the instance of virtual appliance 1820 may be implemented on one or more of virtual machines 1840, and the implementations may be made in different ways.

During operation, processing circuitry 1860 executes software 1895 to instantiate the hypervisor or virtualization layer 1850, which may sometimes be referred to as a virtual machine monitor (VMM). Virtualization layer 1850 may present a virtual operating platform that appears like networking hardware to virtual machine 1840.

As shown in FIG. 18, hardware 1830 may be a standalone network node with generic or specific components. Hardware 1830 may comprise antenna 18225 and may implement some functions via virtualization. Alternatively, hardware 1830 may be part of a larger cluster of hardware (e.g. such as in a data center or customer premise equipment (CPE)) where many hardware nodes work together and are managed via management and orchestration (MANO) 18100, which, among others, oversees lifecycle management of applications 1820.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 1840 may be a software implementation of a physical machine that runs programs as if they were executing on a physical, non-virtualized machine. Each of virtual machines 1840, and that part of hardware 1830 that executes that virtual machine, be it hardware dedicated to that virtual machine and/or hardware shared by that virtual machine with others of the virtual machines 1840, forms a separate virtual network elements (VNE).

Still in the context of NFV, Virtual Network Function (VNF) is responsible for handling specific network functions that run in one or more virtual machines 1840 on top of hardware networking infrastructure 1830 and corresponds to application 1820 in FIG. 18.

In some embodiments, one or more radio units 18200 that each include one or more transmitters 18220 and one or more receivers 18210 may be coupled to one or more antennas 18225. Radio units 18200 may communicate directly with hardware nodes 1830 via one or more appropriate network interfaces and may be used in combination with the virtual components to provide a virtual node with radio capabilities, such as a radio access node or a base station.

In some embodiments, some signalling can be effected with the use of control system 18230 which may alternatively be used for communication between the hardware nodes 1830 and radio units 18200.

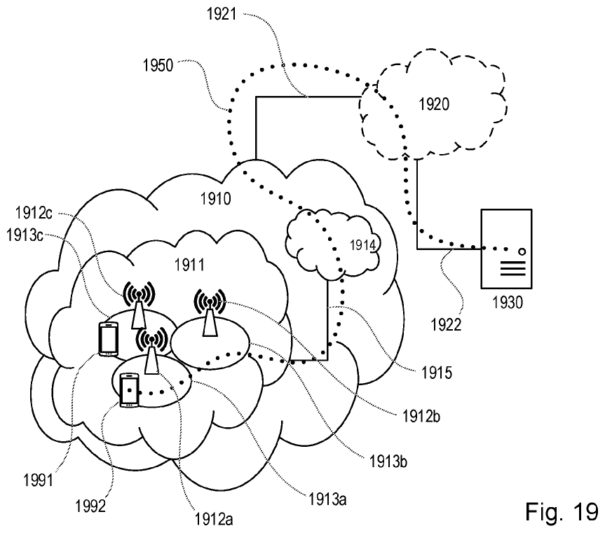

With reference to FIG. 19, in accordance with an embodiment, a communication system includes telecommunication network 1910, such as a 3GPP-type cellular network, which comprises access network 1911, such as a radio access network, and core network 1914. Access network 1911 comprises a plurality of base stations 1912a, 1912b, 1912c, such as NBs, eNBs, gNBs or other types of wireless access points, each defining a corresponding coverage area 1913a, 1913b, 1913c. Each base station 1912a, 1912b, 1912c is connectable to core network 1914 over a wired or wireless connection 1915. A first UE 1991 located in coverage area 1913c is configured to wirelessly connect to, or be paged by, the corresponding base station 1912c. A second UE 1992 in coverage area 1913a is wirelessly connectable to the corresponding base station 1912a. While a plurality of UEs 1991, 1992 are illustrated in this example, the disclosed embodiments are equally applicable to a situation where a sole UE is in the coverage area or where a sole UE is connecting to the corresponding base station 1912.

Telecommunication network 1910 is itself connected to host computer 1930, which may be embodied in the hardware and/or software of a standalone server, a cloud-implemented server, a distributed server or as processing resources in a server farm. Host computer 1930 may be under the ownership or control of a service provider, or may be operated by the service provider or on behalf of the service provider. Connections 1921 and 1922 between telecommunication network 1910 and host computer 1930 may extend directly from core network 1914 to host computer 1930 or may go via an optional intermediate network 1920. Intermediate network 1920 may be one of, or a combination of more than one of, a public, private or hosted network; intermediate network 1920, if any, may be a backbone network or the Internet; in particular, intermediate network 1920 may comprise two or more sub-networks (not shown).

The communication system of FIG. 19 as a whole enables connectivity between the connected UEs 1991, 1992 and host computer 1930. The connectivity may be described as an over-the-top (OTT) connection 1950. Host computer 1930 and the connected UEs 1991, 1992 are configured to communicate data and/or signaling via OTT connection 1950, using access network 1911, core network 1914, any intermediate network 1920 and possible further infrastructure (not shown) as intermediaries. OTT connection 1950 may be transparent in the sense that the participating communication devices through which OTT connection 1950 passes are unaware of routing of uplink and downlink communications. For example, base station 1912 may not or need not be informed about the past routing of an incoming downlink communication with data originating from host computer 1930 to be forwarded (e.g., handed over) to a connected UE 1991. Similarly, base station 1912 need not be aware of the future routing of an outgoing uplink communication originating from the UE 1991 towards the host computer 1930.

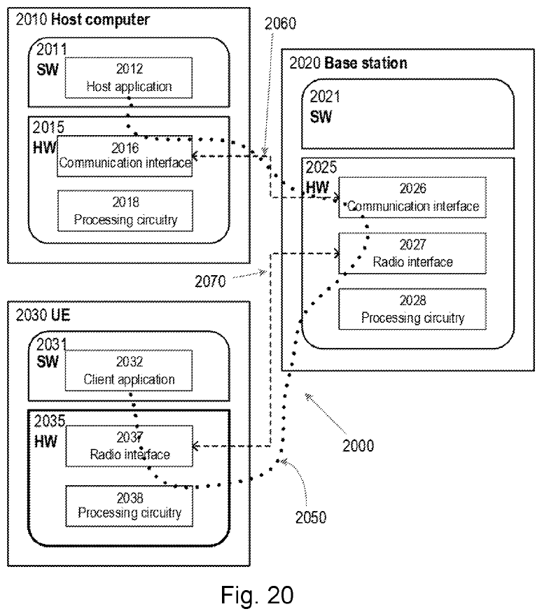

Example implementations, in accordance with an embodiment, of the UE, base station and host computer discussed in the preceding paragraphs will now be described with reference to FIG. 20. In communication system 2000, host computer 2010 comprises hardware 2015 including communication interface 2016 configured to set up and maintain a wired or wireless connection with an interface of a different communication device of communication system 2000. Host computer 2010 further comprises processing circuitry 2018, which may have storage and/or processing capabilities. In particular, processing circuitry 2018 may comprise one or more programmable processors, application-specific integrated circuits, field programmable gate arrays or combinations of these (not shown) adapted to execute instructions. Host computer 2010 further comprises software 2011, which is stored in or accessible by host computer 2010 and executable by processing circuitry 2018. Software 2011 includes host application 2012. Host application 2012 may be operable to provide a service to a remote user, such as UE 2030 connecting via OTT connection 2050 terminating at UE 2030 and host computer 2010. In providing the service to the remote user, host application 2012 may provide user data which is transmitted using OTT connection 2050.

Communication system 2000 further includes base station 2020 provided in a telecommunication system and comprising hardware 2025 enabling it to communicate with host computer 2010 and with UE 2030. Hardware 2025 may include communication interface 2026 for setting up and maintaining a wired or wireless connection with an interface of a different communication device of communication system 2000, as well as radio interface 2027 for setting up and maintaining at least wireless connection 2070 with UE 2030 located in a coverage area (not shown in FIG. 20) served by base station 2020. Communication interface 2026 may be configured to facilitate connection 2060 to host computer 2010. Connection 2060 may be direct or it may pass through a core network (not shown in FIG. 20) of the telecommunication system and/or through one or more intermediate networks outside the telecommunication system. In the embodiment shown, hardware 2025 of base station 2020 further includes processing circuitry 2028, which may comprise one or more programmable processors, application-specific integrated circuits, field programmable gate arrays or combinations of these (not shown) adapted to execute instructions. Base station 2020 further has software 2021 stored internally or accessible via an external connection.

Communication system 2000 further includes UE 2030 already referred to. Its hardware 2035 may include radio interface 2037 configured to set up and maintain wireless connection 2070 with a base station serving a coverage area in which UE 2030 is currently located. Hardware 2035 of UE 2030 further includes processing circuitry 2038, which may comprise one or more programmable processors, application-specific integrated circuits, field programmable gate arrays or combinations of these (not shown) adapted to execute instructions. UE 2030 further comprises software 2031, which is stored in or accessible by UE 2030 and executable by processing circuitry 2038. Software 2031 includes client application 2032. Client application 2032 may be operable to provide a service to a human or non-human user via UE 2030, with the support of host computer 2010. In host computer 2010, an executing host application 2012 may communicate with the executing client application 2032 via OTT connection 2050 terminating at UE 2030 and host computer 2010. In providing the service to the user, client application 2032 may receive request data from host application 2012 and provide user data in response to the request data. OTT connection 2050 may transfer both the request data and the user data. Client application 2032 may interact with the user to generate the user data that it provides.

It is noted that host computer 2010, base station 2020 and UE 2030 illustrated in FIG. 20 may be similar or identical to host computer 1930, one of base stations 1912a, 1912b, 1912c and one of UEs 1991, 1992 of FIG. 19, respectively. This is to say, the inner workings of these entities may be as shown in FIG. 20 and independently, the surrounding network topology may be that of FIG. 19.

In FIG. 20, OTT connection 2050 has been drawn abstractly to illustrate the communication between host computer 2010 and UE 2030 via base station 2020, without explicit reference to any intermediary devices and the precise routing of messages via these devices. Network infrastructure may determine the routing, which it may be configured to hide from UE 2030 or from the service provider operating host computer 2010, or both. While OTT connection 2050 is active, the network infrastructure may further take decisions by which it dynamically changes the routing (e.g., on the basis of load balancing consideration or reconfiguration of the network).

Wireless connection 2070 between UE 2030 and base station 2020 is in accordance with the teachings of the embodiments described throughout this disclosure. One or more of the various embodiments improve the performance of OTT services provided to UE 2030 using OTT connection 2050, in which wireless connection 2070 forms the last segment.

A measurement procedure may be provided for the purpose of monitoring data rate, latency and other factors on which the one or more embodiments improve. There may further be an optional network functionality for reconfiguring OTT connection 2050 between host computer 2010 and UE 2030, in response to variations in the measurement results. The measurement procedure and/or the network functionality for reconfiguring OTT connection 2050 may be implemented in software 2011 and hardware 2015 of host computer 2010 or in software 2031 and hardware 2035 of UE 2030, or both. In embodiments, sensors (not shown) may be deployed in or in association with communication devices through which OTT connection 2050 passes; the sensors may participate in the measurement procedure by supplying values of the monitored quantities exemplified above, or supplying values of other physical quantities from which software 2011, 2031 may compute or estimate the monitored quantities. The reconfiguring of OTT connection 2050 may include message format, retransmission settings, preferred routing etc.; the reconfiguring need not affect base station 2020, and it may be unknown or imperceptible to base station 2020. Such procedures and functionalities may be known and practiced in the art. In certain embodiments, measurements may involve proprietary UE signaling facilitating host computer 2010's measurements of throughput, propagation times, latency and the like. The measurements may be implemented in that software 2011 and 2031 causes messages to be transmitted, in particular empty or ‘dummy’ messages, using OTT connection 2050 while it monitors propagation times, errors etc.

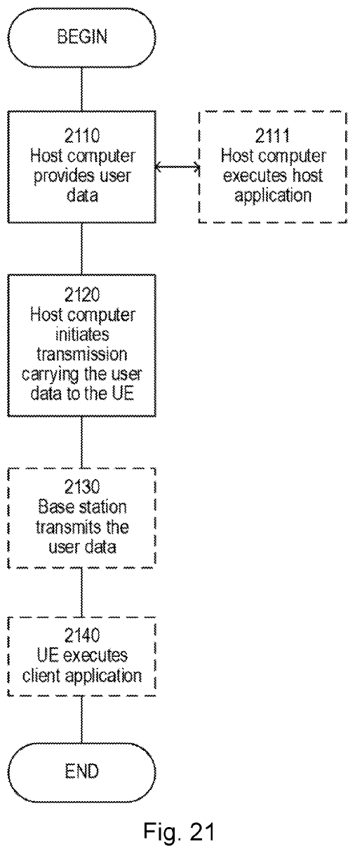

FIG. 21 is a flowchart illustrating a method implemented in a communication system, in accordance with one embodiment. The communication system includes a host computer, a base station and a UE which may be those described with reference to FIGS. 19 and 20. For simplicity of the present disclosure, only drawing references to FIG. 21 will be included in this section. In step 2110, the host computer provides user data. In substep 2111 (which may be optional) of step 2110, the host computer provides the user data by executing a host application. In step 2120, the host computer initiates a transmission carrying the user data to the UE. In step 2130 (which may be optional), the base station transmits to the UE the user data which was carried in the transmission that the host computer initiated, in accordance with the teachings of the embodiments described throughout this disclosure. In step 2140 (which may also be optional), the UE executes a client application associated with the host application executed by the host computer.

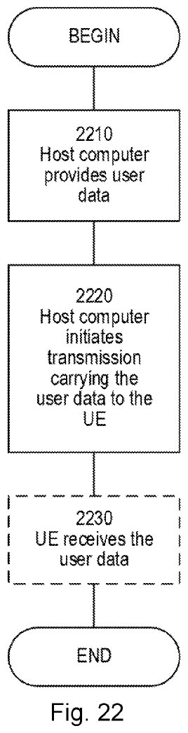

FIG. 22 is a flowchart illustrating a method implemented in a communication system, in accordance with one embodiment. The communication system includes a host computer, a base station and a UE which may be those described with reference to FIGS. 19 and 20. For simplicity of the present disclosure, only drawing references to FIG. 22 will be included in this section. In step 2210 of the method, the host computer provides user data. In an optional substep (not shown) the host computer provides the user data by executing a host application. In step 2220, the host computer initiates a transmission carrying the user data to the UE. The transmission may pass via the base station, in accordance with the teachings of the embodiments described throughout this disclosure. In step 2230 (which may be optional), the UE receives the user data carried in the transmission.

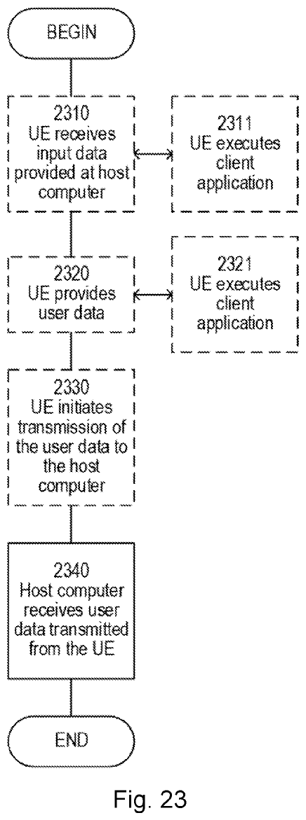

FIG. 23 is a flowchart illustrating a method implemented in a communication system, in accordance with one embodiment. The communication system includes a host computer, a base station and a UE which may be those described with reference to FIGS. 19 and 20. For simplicity of the present disclosure, only drawing references to FIG. 23 will be included in this section. In step 2310 (which may be optional), the UE receives input data provided by the host computer. Additionally or alternatively, in step 2320, the UE provides user data. In substep 2321 (which may be optional) of step 2320, the UE provides the user data by executing a client application. In substep 2311 (which may be optional) of step 2310, the UE executes a client application which provides the user data in reaction to the received input data provided by the host computer. In providing the user data, the executed client application may further consider user input received from the user. Regardless of the specific manner in which the user data was provided, the UE initiates, in substep 2330 (which may be optional), transmission of the user data to the host computer. In step 2340 of the method, the host computer receives the user data transmitted from the UE, in accordance with the teachings of the embodiments described throughout this disclosure.

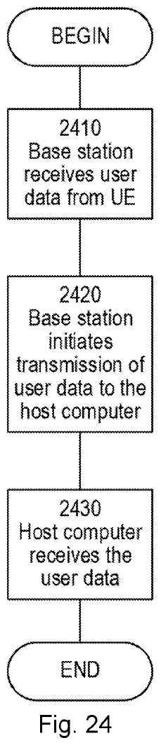

FIG. 24 is a flowchart illustrating a method implemented in a communication system, in accordance with one embodiment. The communication system includes a host computer, a base station and a UE which may be those described with reference to FIGS. 19 and 20. For simplicity of the present disclosure, only drawing references to FIG. 24 will be included in this section. In step 2410 (which may be optional), in accordance with the teachings of the embodiments described throughout this disclosure, the base station receives user data from the UE. In step 2420 (which may be optional), the base station initiates transmission of the received user data to the host computer. In step 2430 (which may be optional), the host computer receives the user data carried in the transmission initiated by the base station.

The methods of the present disclosure may be implemented in hardware, or as software modules running on one or more processors. The methods may also be carried out according to the instructions of a computer program, and the present disclosure also provides a computer readable medium having stored thereon a program for carrying out any of the methods described herein. A computer program embodying the disclosure may be stored on a computer readable medium, or it could, for example, be in the form of a signal such as a downloadable data signal provided from an Internet website, or it could be in any other form.

It should be noted that the above-mentioned examples illustrate rather than limit the disclosure, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1. A method for managing a wireless device that is operable to connect to a communication network, wherein the communication network comprises a Radio Access Network (RAN), and wherein the wireless device has available for execution a Machine Learning (ML) model that is operable to provide an output, on the basis of which a RAN operation performed by the wireless device may be configured, the method, performed by a RAN node of the communication network, comprising:
on fulfilment of a trigger condition, causing an ML model Assurance Information (MAI) Request to be sent to the wireless device, the MAI Request comprising an indication of the ML model to which the MAI Request relates;
receiving, from the wireless device, an MAI Response, wherein the MAI Response comprises ML model characteristic information generated by the wireless device using the ML model; and
configuring the RAN operation performed by the wireless device according to the received MAI Response.

2-32. (canceled)

33. A method for managing a wireless device that is operable to connect to a communication network, wherein the communication network comprises a Radio Access Network (RAN), and wherein the wireless device has available for execution a Machine Learning (ML) model that is operable to provide an output, on the basis of which a RAN operation performed by the wireless device may be configured, the method, performed by the wireless device, comprising:
receiving, from a RAN node of the communication network, an ML model Assurance Information (MAI) Request, the MAI Request comprising an indication of the ML model to which the MAI Request relates;
generating ML model characteristic information using the ML model indicated in the MAI Request; and
transmitting, to the RAN node, an MAI Response, wherein the MAI Response comprises the generated ML model characteristic information.

34. The method of claim 33, further comprising:
receiving, from the RAN node, information for configuration of the RAN operation performed by the wireless device.

35. The method of claim 33, wherein generating the ML model characteristic using the ML model comprises generating a value using at least one of:
the ML model;
one or more parameters of the ML model.

36. The method of claim 33, further comprising:
obtaining the ML model by performing at least one of:
receiving the ML model in a transmission;
receiving an instruction to download the ML model from a repository using an authenticated connection, and downloading the ML model according to the instruction.

37. The method of claim 36, wherein obtaining the ML model comprises obtaining a version of the ML model that comprises at least one difference from a version of the model obtained by another wireless device, wherein the difference is such that the characteristic information for the ML model will be different to characteristic information for the version of the ML model obtained by the other wireless device.

38. The method of claim 33, wherein generating the ML model characteristic information using the ML model comprises:
generating a function of the ML model or at least one ML model parameter.

39. (canceled)

40. The method of claim 33, wherein generating the ML model characteristic information using the ML model comprises:
providing a specific assurance input to the ML model; and
generating a function of the ML model that corresponds to the specific assurance input provided by the wireless device to the ML model.

41. The method of claim 40, wherein the function comprises at least one of:
an output of the ML model; or
an input or output of an activation function of an intermediate element of the ML model.

42. The method of claim 40, further comprising obtaining the specific assurance input from the RAN node.

43. The method of claim 42, wherein obtaining the specific assurance input from the RAN node comprises obtaining an assurance input that is different to an assurance input provided to another wireless device.

44. The method of claim 42, wherein obtaining the specific assurance input from the RAN node comprises obtaining from the RAN node a seed value and inputting the seed value to a Pseudo Random Number Generator, PRNG, in order to generate the assurance input.

45. The method of claim 33, wherein generating the ML model characteristic information using the ML model comprises:
generating a combination of an output of the ML model and an identifier of the version of the ML model used to generate the output.

46. The method of claim 45, wherein the identifier of the version of the ML model comprises at least one of:
an assigned alphanumeric identifier;
a function of parameters of the version of the ML model.

47. The method of claim 33, wherein generating the ML model characteristic information using the ML model comprises:
deriving a value from the ML model and an information item available to both the wireless device and the RAN node.

48-51. (canceled)

52. The method of claim 33, wherein generating the ML model characteristic information using the ML model comprises:
calculating a function of a derivative of at least one of the weights of the ML model, wherein the derivative is calculated using a secret shared with the RAN node.

53-55. (canceled)

56. The method of claim 34, wherein receiving, from the RAN node, information for configuration of the RAN operation performed by the wireless device comprises receiving at least one of:
an instruction to perform the RNO operation without using the ML model;
an instruction to perform additional measurements;
a correct current version of the ML model for wireless device;
a warning from the RAN node.

57. The method of claim 33, wherein the RAN operation performed by the wireless device comprises at least one of:
beam measurement prediction;
secondary carrier prediction;
signal quality forecast;
signal quality drop prediction;
compression of radio measurements;
power control in uplink, UL, transmission;
timing advance in UL transmission;
link adaptation in UL transmission;
estimation of performance metrics;
information compression for UL transmission;
coverage estimation for secondary carrier;
estimation of signal quality degradation;
estimation of signal strength degradation;
a mobility related operation;
an energy saving operation;
a positioning operation.

58. (canceled)

59. A Radio Access Network (RAN) node of a communication network comprising a RAN, wherein the RAN node is for managing a wireless device that is operable to connect to a communication network, and wherein the wireless device has available for execution a Machine Learning (ML) model that is operable to provide an output, on the basis of which a RAN operation performed by the wireless device may be configured, the RAN node comprising processing circuitry configured to cause the RAN node to:
on fulfilment of a trigger condition, cause an ML model Assurance Information (MAI) Request to be sent to the wireless device, the MAI Request comprising an indication of the ML model to which the MAI Request relates;
receive, from the wireless device, an MAI Response, wherein the MAI Response comprises ML model characteristic information generated by the wireless device using the ML model; and
configure the RAN operation performed by the wireless device according to the received MAI Response.

60. (canceled)

61. A wireless device that is operable to connect to a communication network, wherein the communication network comprises a Radio Access Network (RAN), and wherein the wireless device has available for execution a Machine Learning (ML) model that is operable to provide an output, on the basis of which a RAN operation performed by the wireless device may be configured, the wireless device comprising processing circuitry configured to cause the wireless device to:
receive, from a RAN node of the communication network, an ML model Assurance Information (MAI) Request, the MAI Request comprising an indication of the ML model to which the MAI Request relates;
generate ML model characteristic information using the ML model indicated in the MAI Request; and
transmit, to the RAN node, an MAI Response, wherein the MAI Response comprises the generated ML model characteristic information.

62. (canceled)
